(19) United States
(12) Patent Application Publication
(10) Pub. No.: US 2011/0245007 A1
(43) Pub. Date: Oct. 6, 2011

(54) POWER TRANSMISSION DEVICE FOR FRONT AND REAR WHEEL DRIVE VEHICLE

(75) Inventor: Takahiro Yoshimura, Toyota-shi (JP)

(73) Assignee: TOYOTA JIDOSHA KABUSHIKI KAISHA, Toyota-shi, Aichi (JP)

(21) Appl. No.: 13/133,545

(22) PCT Filed: Dec. 9, 2008
(86) PCT No.: PCT/JP2008/072289

§ 371 Date: Jun. 8, 2011

(51) Int. Cl. F16H 48/30

(52) U.S. Cl. 475/150; 903/910

(57) ABSTRACT

A power transmission device for a front and rear wheel drive vehicle including: an electric type differential portion having a differential state between a rotation speed of a differential input member and a rotation speed of a differential output member controlled by controlling an operational sate of a first rotating machine coupled to a rotating element of a differential mechanism in a power transmittable manner; a second rotating machine disposed for at least one of front and rear wheels in a power transmittable manner; and a front and rear wheel power distribution device having three rotating elements that are an input rotating element, a first output rotating element operatively coupled to a first wheel that is one of the front and rear wheels, and a second output rotating element operatively coupled to a second wheel that is the other of the front and rear wheels, the front and rear wheel power distribution device distributing power to the first output rotating element and the second output rotating element, the power being input from the differential output member to the input rotation element, the front and rear wheel power distribution device being configured such that the input rotating element, the first output rotating element, and the second output rotating element are arranged in series from one end to the other end on a collinear diagram capable of representing rotation speeds of the three rotating elements on a straight line, a gear ratio from the first output rotating element to the first wheel being different from a gear ratio from the second output rotating element to the second wheel.

### TECHNICAL FIELD

The present invention relates to a power transmission device for a front and rear wheel drive vehicle having an electric type differential portion, and, more particularly, to a technique for improving fuel economy during high-speed traveling and power performance during acceleration traveling.

### BACKGROUND ART

It is suggested a power transmission device for a front and rear wheel drive vehicle including: (a) an electric type differential portion having a differential state between a rotation speed of a differential input member and a rotation speed of a differential output member controlled by controlling an operational sate of a first rotating machine coupled to a rotating element of a differential mechanism in a power transmittable manner; (b) a second rotating machine disposed for at least one of front and rear wheels in a power transmittable manner; and (c) a front and rear wheel power distribution device having three rotating elements that are an input rotating element, a first output rotating element operatively coupled to a first wheel that is one of the front and rear wheels, and a second output rotating element operatively coupled to a second wheel that is the other of the front and rear wheels, the front and rear wheel power distribution device distributing power to the first output rotating element and the second output rotating element, the power being input from the differential output member to the input rotation element. (See Patent Document 1)

One example is a power transmission device 100 of a hybrid vehicle having a general configuration (schematic) depicted in FIG. 14A, which includes an electric type differential portion 102 and a front and rear wheel power distribution device 104. The electric type differential portion 102 includes a single pinion type differential planetary gear device 106 as a differential mechanism, and a carrier SCA of the differential planetary gear device 106 is coupled via a differential input shaft 108, etc., as a differential input member to an engine 110 used as a main drive power source. A sun gear SS is coupled to a first motor generator MG1 as a first rotating machine, and a ring gear SR is integrally coupled to a differential output member 112. The front and rear wheel power distribution device 104 is made up mainly of a double pinion type distribution planetary gear device 114, and a ring gear CR of the distribution planetary gear device 114 is an input rotating element and is integrally coupled to the differential output member 112. A sun gear CS is a first output rotating element and is operatively coupled to rear wheels via a rear-wheel output shaft 116, etc., and a carrier CA is a second output rotating element and is operatively coupled to front wheels via a front-wheel output gear 118, etc. The rear-wheel output shaft 116 is coupled to a second motor generator MG2 as a second rotational machine in a power transmittable manner.

As depicted in a collinear diagram of FIG. 15 capable of representing the rotation speeds of the portions of the electric type differential portion 102 with a straight line, the power transmission device 100 as described above controls an engine rotation speed NE, i.e., the rotation speed of the differential input shaft 108 in consideration of fuel economy, etc., and performs the regenerative control of the first motor generator MG1 so as to achieve a predetermined rotation speed NMG1 determined depending on the rotation speed of the differential output member 112. i.e., vehicle speed V. The power running control of the second motor generator MG2 is performed with the electric energy acquired from the regenerative control of the first motor generator MG1 to add an assist torque to the rear wheel side, and an engine load is correspondingly reduced. A ratio of intervals among the rotating elements (SS, SCA, SR) in the collinear diagram of FIG. 15 is determined depending on a gear ratio ρS (=number of teeth of sun gear/number of teeth of ring gear) of the differential planetary gear device 106. FIG. 15 also depicts a collinear diagram related to the front and rear wheel power distribution device 104; “Rr” is the rotation speed of the rear-wheel output shaft 116, i.e., the rotation speed of the sun gear CS; “Fr” is the rotation speed of the front-wheel output gear 118, i.e., the rotation speed of the carrier CCA; and this example represents the case that the gear ratio from the rear-wheel output shaft 116 to the rear wheel is the same as the gear ratio from the front-wheel output gear 118 to the front wheel with the rotation speeds thereof equivalent to each other. For the front and rear wheel power distribution device 104, a ratio of intervals among three rotating elements including the ring gear CR is also determined depending on a gear ratio ρC of the distribution planetary gear device 114.
Patent Document 1: Japanese Laid-Open Patent Publication No. 2004-114944

### DISCLOSURE OF THE INVENTION

### Problem to be Solved by the Invention

However, such a conventional power transmission device still has room for improvement because energy circulation occurs during high-speed traveling, resulting in deterioration of energy efficiency (such as fuel economy) and a rotation speed of a differential input member is limited during acceleration traveling, resulting in restriction of the power performance, etc. Specifically describing in terms of the power transmission device 100 of FIG. 14A, when the rotation speed NMG1 of the first motor generator MG1 is reduced in accordance with increase in the vehicle speed V and is made rotated inversely as indicated by a solid line of FIG. 16A, the first motor generator MG1 must be subjected to the power running control and, if the electric energy in this case is recovered through the regeneration control of the second motor generator MG2, since the power transmitted from the engine 110 to the second motor generator MG2 is converted into electric energy and the electric energy is used for the power running control of the first motor generator MG1 of the electric type differential portion 102 located on the upstream side, the energy circulation occurs therebetween, deteriorating the energy efficiency. Although the rotation speed NMG1 of the first motor generator MG1 is increased during acceleration traveling at startup, etc., as indicated by a solid line of FIG. 16B, the rotation speed NMG1 may be limited to a predetermined allowable maximum rotation speed NMG1max or lower so as to prevent overcharge of an electric storage device or the like and, as a result, sufficient output may not be acquired due to the restriction on increase in the engine rotation speed NE.

On the other hand, although not known yet, it is contemplated that an automatic transmission 122 is disposed on the rear wheel side of the power transmission device 100 as in a power transmission device 120 depicted in FIG. 14B, for example. If the gear ratio of the automatic transmission 122 is selectable from a speed-decreasing gear ratio larger than one to a speed-increasing gear ratio smaller than one, when the gear ratio is made smaller than one during high-speed traveling, the rotation speed of the rear-wheel output shaft 116 decreases while if the gear ratio is made greater than one during acceleration traveling, the rotation speed of the rear-wheel output shaft 116 increases. Therefore, as depicted in the collinear diagrams in this case represented by dot-lines of FIGS. 16A and 16B, although the energy circulation during high-speed traveling is reduced and the restriction on increase in the engine rotation speed NE during acceleration traveling is alleviated, the rotation speed of the differential output member 112, i.e., the rotation speed of the ring gear SR is higher than the rotation speed of the rear-wheel output shaft 116 (sun gear CS) during high-speed traveling and lower than the rotation speed of the rear-wheel output shaft 116 (sun gear CS) during acceleration traveling, which is not sufficiently satisfiable, and further improvement is desired.

The present invention was conceived in view of the situations and it is therefore an object of the present invention to allow a power transmission device for a front and rear wheel drive vehicle having an electric type differential portion to restrict the energy circulation during high-speed traveling for further improvement in energy efficiency or to further alleviate the restriction on the rotation speed of the differential input member during acceleration traveling, thereby acquiring excellent power performance.

### Means for Solving the Problem

The object indicated above can be achieved according to a first aspect of the present invention, which provides a power transmission device for a front and rear wheel drive vehicle including: (a) an electric type differential portion having a differential state between a rotation speed of a differential input member and a rotation speed of a differential output member controlled by controlling an operational sate of a first rotating machine coupled to a rotating element of a differential mechanism in a power transmittable manner; (b) a second rotating machine disposed for at least one of front and rear wheels in a power transmittable manner; and (c) a front and rear wheel power distribution device having three rotating elements that are an input rotating element, a first output rotating element operatively coupled to a first wheel that is one of the front and rear wheels, and a second output rotating element operatively coupled to a second wheel that is the other of the front and rear wheels, the front and rear wheel power distribution device distributing power to the first output rotating element and the second output rotating element, the power being input from the differential output member to the input rotation element, (d) the front and rear wheel power distribution device being configured such that the input rotating element, the first output rotating element, and the second output rotating element are arranged in series from one end to the other end on a collinear diagram capable of representing rotation speeds of the three rotating elements on a straight line, (e) a gear ratio from the first output rotating element to the first wheel being different from a gear ratio from the second output rotating element to the second wheel.

The object indicated above can be achieved according to a second aspect of the present invention, which provides the power transmission device for a front and rear wheel drive vehicle of the first aspect of the invention, wherein the gear ratio from the first output rotating element to the first wheel is smaller than the gear ratio from the second output rotating element to the second wheel.

The object indicated above can be achieved according to a third aspect of the present invention, which provides the power transmission device for a front and rear wheel drive vehicle of the first aspect of the invention, wherein the gear ratio from the first output rotating element to the first wheel is greater than the gear ratio from the second output rotating element to the second wheel.

The object indicated above can be achieved according to a fourth aspect of the present invention, which provides the power transmission device for a front and rear wheel drive vehicle of any one of the first to third aspects of the present invention, including a shifting portion on a power transmission path from the first output rotating element to the first wheel, the shifting portion having a gear ratio selectable from a speed-decreasing gear ratio larger than one to a speed-increasing gear ratio smaller than one, wherein the gear ratio from the first output rotating element to the first wheel is made smaller than the gear ratio from the second output rotating element to the second wheel by selecting the speed-increasing gear ratio during high-speed traveling, and wherein the gear ratio from the first output rotating element to the first wheel is made greater than the gear ratio from the second output rotating element to the second wheel by selecting the speed-decreasing gear ratio during acceleration traveling.

The object indicated above can be achieved according to a fifth aspect of the present invention, which provides the power transmission device for a front and rear wheel drive vehicle of the second or fourth aspect of the invention, comprising a high-speed traveling differential control means that performs power running control to rotationally drive the first rotating machine depending on the rotation speed of the differential output member such that the rotation speed of the differential input member is maintained at a predetermined value during acceleration traveling while performing regenerative control of the second rotating machine to recover electric energy.

The object indicated above can be achieved according to a fifth aspect of the present invention, which provides the power transmission device for a front and rear wheel drive vehicle of the third or fourth aspect of the invention, including an acceleration traveling differential control means that performs regenerative control of the first rotating machine during acceleration traveling to recover electric energy while limiting the rotation speed of the first rotating machine during the regenerative control in accordance with a predetermined regenerative condition.

### Advantages of the Invention

This power transmission device of a front and rear wheel drive vehicle is configured such that an input rotation element, a first output rotation element, and a second output rotation element are arranged in series from one end to the other end on a collinear diagram capable of representing the rotation speeds of the three rotation elements of the front and rear wheel power distribution device on a straight line. Therefore, if the gear ratio from the first output rotation element to the first wheel is different from the gear ratio from the second output rotation element to the second wheel due to the presence/absence of the automatic transmission and a difference between the final reduction ratios of the first and second wheels, the rotation speed of the input rotation element located at the end of the collinear diagram among the three rotation elements is maximized or minimized. Therefore, if the gear ratios are determined such that the rotation speed of the input rotation element is reduced during high-sped traveling, specifically, if the gear ratio on the first wheel side is set smaller than the gear ratio on the second wheel side, a change in the rotation is suppressed in the power running rotation direction of the first rotating machine coupled to the electric type differential portion correspondingly to the reduction of the rotation speed of the input rotation element. Therefore, the energy circulation becomes difficult to occur or the rotation speed in the power running rotation direction is lowered and an energy loss due to the energy circulation is reduced, and the energy efficiency is improved. If the gear ratios are determined such that the rotation speed of the input rotation element is increased during acceleration traveling at startup, etc., specifically, if the gear ratio on the first wheel side is set greater than the gear ratio on the second wheel side, the rotation speed of the differential input member is allowed to increase correspondingly to the increase in the rotation speed of the input rotation element and, therefore, the rotation speed of the drive power source such as the engine coupled to the differential input member can be increased to improve the power performance (power).

In the second aspect of the invention, the gear ratio from the first output rotating element to the first wheel is smaller than the gear ratio from the second output rotating element to the second wheel, the rotation speed of the input rotation element, and, further, the rotation speed of the differential output member of the electric type differential portion are reduced. Therefore, for instance, in the case of the fifth aspect of the invention in which a high-speed traveling differential control means performs power running control to rotationally drive the first rotating machine depending on the rotation speed of the differential output member such that the rotation speed of the differential input member is maintained at a predetermined value during acceleration traveling while performing regenerative control of the second rotating machine to recover electric energy, a change in the rotation is suppressed in the power running rotation direction of the first rotating machine coupled to the electric type differential portion correspondingly to the reduction of the rotation speed of the differential output member. Therefore, the energy circulation becomes difficult to occur or an energy loss due to the energy circulation is reduced, and the energy efficiency is improved. Even if the high-speed traveling differential control means of the fifth aspect of the invention is not included and the first rotating machine is always subjected to the regenerative control without changing the rotation in the power running rotation direction while traveling, the vehicle speed can be increased while suppressing increase in the rotation of the differential input member correspondingly to the reduction of the rotation speed of the differential output member, and the maximum vehicle speed can be raised while avoiding the deterioration of the energy efficiency due to the energy circulation.

In the third aspect of the invention, the gear ratio from the first output rotating element to the first wheel is greater than the gear ratio from the second output rotating element to the second wheel, the rotation speed of the input rotation element, and, further, the rotation speed of the differential output member of the electric type differential portion are increased. Therefore, for instance, in the case of the sixth aspect of the invention in which an acceleration traveling differential control means performs regenerative control of the first rotating machine during acceleration traveling to recover electric energy while limiting the rotation speed of the first rotating machine during the regenerative control in accordance with a predetermined regenerative condition, the restriction on increase in the rotation speed of the differential input member due to the rotation speed limitation of the first rotating machine is alleviated correspondingly to the increase of the rotation speed of the differential output member and the rotation speed of the drive power source such as the engine coupled to the differential input member can be increased to acquire excellent power performance. Even if the acceleration traveling differential control means of the sixth aspect of the invention is not included and the rotation speed of the first rotating machine is not limited at the time of the regenerative control thereof, the rotation speed of the differential input member is allowed to increase correspondingly to the increase in the rotation speed of the differential output member and, therefore, the rotation speed of the drive power source such as the engine coupled to the differential input member can be increased to improve the power performance.

In the fourth aspect of the invention, the power transmission device for a front and rear wheel drive vehicle includes a shifting portion on a power transmission path from the first output rotating element to the first wheel, the shifting portion having a gear ratio selectable from a speed-decreasing gear ratio larger than one to a speed-increasing gear ratio smaller than one, wherein the gear ratio from the first output rotating element to the first wheel is made smaller than the gear ratio from the second output rotating element to the second wheel by selecting the speed-increasing gear ratio during high-speed traveling, and wherein the gear ratio from the first output rotating element to the first wheel is made greater than the gear ratio from the second output rotating element to the second wheel by selecting the speed-decreasing gear ratio during acceleration traveling, during the high-speed traveling, as well as in the second aspect of the invention, a change in the rotation is suppressed in the power running rotation direction of the first rotating machine correspondingly to the reduction of the rotation speed of the differential output member, and, therefore, the energy efficiency is improved, while, during the acceleration traveling, as well as in the third aspect of the invention, the increase in the rotation speed of the differential input member correspondingly to the increase of the rotation speed of the differential output member is allowed and the rotation speed of the drive power source such as the engine coupled to the differential input member can be increased to acquire excellent power performance.

### BRIEF DESCRIPTION OF THE DRAWINGS

FIG. 1 is a schematic for explaining a power transmission device of a front and rear wheel drive vehicle according to the present invention.

FIG. 2A is a schematic of an example of an automatic transmission for the power transmission device in FIG. 1, and FIG. 2B depicts an operation table for explaining engagement of friction engagement devices for establishing a plurality of gear stages in the automatic transmission in FIG. 2A.

FIG. 3 illustrates an example of a set of input/output signals to/from an electronic control device provided in the power transmission device in FIG. 1.

FIG. 4 is a diagram of an example of a shift operation device provided in the power transmission device in FIG. 1.

FIG. 5 is a functional block line diagram for explaining a main portion of the control function of the electronic control device in FIG. 3.

FIG. 6 depicts an example of the shifting map used for shifting control of the automatic transmission together with the drive power source map used for drive power source switching control to switch engine traveling and motor traveling.

FIG. 7 depicts an example of the fuel consumption property map stored in the power transmission device in FIG. 1.

FIGS. 8A and 8B are collinear diagrams depicting the relationship among rotation speeds of three rotation elements of the electric type differential portion in the power transmission device in FIG. 1 on straight lines, together with collinear diagrams of the front and rear wheel power distribution device, an example during the high-speed traveling in FIG. 8A and an example during the acceleration traveling in FIG. 8B.

FIG. 9A depicts an example of the engine rotation speed that causes the energy circulation by the power running control of the first motor generator MG1 during the high-speed traveling, and FIG. 9B depicts an example of the engine rotation speed that is limited by the rotation speed limitation of the first motor generator MG1 during the acceleration traveling.

FIGS. 10A and 10B are schematics for explaining another embodiment of the present invention, both having no automatic transmission, the rear-wheel-side final reduction ratio (differential ratio) ir is smaller than the front-wheel-side final reduction ratio (differential ratio) if in FIG. 10A and the rear-wheel-side final reduction ratio ir is larger than the front-wheel-side final reduction ratio if in FIG. 10B.

FIGS. 11A and 11B are schematics for explaining another embodiment of the present invention, applied for a front and rear wheel drive vehicle based on a transverse type front wheel drive vehicle in FIG. 11A and the engaging state of the distribution planetary gear device being different in FIG. 11B.

FIGS. 12A and 12B are schematics for explaining another embodiment of the present invention in which a double pinion type planetary gear device is used as a differential mechanism of the front and rear wheel power distribution device.

FIGS. 13A and 13B are schematics for explaining another embodiment of the present invention, corresponding to FIGS. 8A and 8B, in which the differential output member is coupled to the carrier SCA located in the middle on the collinear diagram of the electric type differential portion

FIGS. 14A and 14B are schematics for explaining examples of the power transmission device of the conventional hybrid type front and rear wheel drive vehicle, and the power transmission device in FIG. 14B includes an automatic transmission on the rear wheel side.

FIGS. 15A and 15B are collinear diagrams depicting the relationship among rotation speeds of three rotation elements of the electric type differential portion in the power transmission device in FIG. 14A on straight lines, together with collinear diagrams of the front and rear wheel power distribution device, an example during normal steady traveling.

FIGS. 16A and 16B are collinear diagrams during high-speed steady traveling and during acceleration traveling for the power transmission devices in FIGS. 14A and 14B, for comparison.

### NOMENCLATURE OF ELEMENTS

10, 200, 202: power transmission device 12, 250: electric type differential portion 14, 210, 220, 230, 240: front and rear wheel power distribution device 16: differential planetary gear device (differential mechanism) 18: differential input shaft (differential input member) 22: differential output member 30: automatic transmission (shifting portion) 34: real wheels (first wheels) 44: front wheels (second wheels) 80: electronic control device 92: high-speed traveling differential control means 94: acceleration traveling differential control means MG1: first motor generator (first rotating machine) MG2: second motor generator (second rotating machine)

### BEST MODES FOR CARRYING OUT THE INVENTION

Although the present invention is preferably applied to a hybrid front and rear wheel drive vehicle having a differential input member of an electric type differential portion to which an internal combustion engine such as a gasoline engine or a diesel engine is coupled as a main drive force source, the main drive force source may be employed as a drive force source other than an internal combustion engine, such as an electric motor or a motor generator.

Although the electric type differential portion includes, for example, a single pinion or double pinion type single planetary gear device as a differential mechanism, various forms are available such as a configuration using a plurality of planetary gear devices or using a bevel gear type differential device. Although this electric type differential portion is configured such that the rotating element coupled to the differential input member is located in the middle on a collinear diagram capable of representing with a straight line the rotation speeds of three rotating elements of the differential mechanism coupled respectively to, for example, the first rotating machine, the differential input member, and the differential output member, the present invention is also applicable to the configuration with the rotating element coupled to the differential output member located in the middle.

The form of control is differentiated in the high-speed traveling differential control means and the acceleration traveling differential control means depending on the coupling form of the electric type differential portion. If the rotating element coupled to the differential input member is configured to be located in the middle on the collinear diagram, the high-speed traveling differential control means performs the power running control to rotate the first rotating machine in a rotation direction opposite to the differential output member depending on the rotation speed of the differential output member, and the acceleration traveling differential control means performs the regenerative control of the first rotating machine to recover electric energy when the first rotating machine is rotationally driven in the same rotation direction as the differential input member. If the rotating element coupled to the differential output member is configured to be located in the middle, the high-speed traveling differential control means performs the power running control to rotate the first rotating machine in the same rotation direction as the differential output member depending on the rotation speed of the differential output member, and the acceleration traveling differential control means performs the regenerative control of the first rotating machine to recover electric energy when the first rotating machine is rotationally driven in the rotation direction opposite to the differential input member.

Although the rotating machines of the first rotating machine and the second rotating machine are rotating electric machines and may preferably be implemented by using motor generators capable of selectively acquire functions of an electric motor and an electric generator, an electric motor or an electric generator may be used depending on the form of the differential control and, for example, an electric generator can be employed as the first rotating machine if the differential control is performed to recover electric energy through the regenerative control of the first rotating machine during acceleration traveling and to limit the rotation speed of the first rotating machine during the regenerative control in accordance with a predetermined regenerative condition as in the sixth aspect of the present invention. The first rotating machine or the second rotating machine can be made up by using both an electric motor and an electric generator.

Although the second rotating machine may be integrally coupled to the power transmission path to the front and rear wheels, various forms may be available such as coupling via an interrupting device such as a clutch or coupling via a transmission that increases or decreases speed. The second rotating machine can be disposed for both the front and rear wheels or can be disposed for both the left and right wheels. The second rotating machine may be coupled at least to the front wheels or the rear wheels in a power transmittable manner and may not necessarily be coupled to the power transmission path from the front and rear wheel power distribution device to the front and rear wheels.

Although the front and rear wheel power distribution device includes, for example, a single pinion or double pinion type single planetary gear device as a differential mechanism as is the case with the electric type differential portion, various forms are available such as a configuration using a plurality of planetary gear devices or using a bevel gear type differential device. If the differential mechanism is a single pinion type planetary gear device, the carrier located in the middle on the collinear diagram is the first output rotating element, and the sun gear and the ring gear correspond to one and the other of the input rotating element and the second output rotating element. If the differential mechanism is a double pinion type planetary gear device, the ring gear located in the middle on the collinear diagram is the first output rotating element, and the sun gear and the carrier correspond to one and the other of the input rotating element and the second output rotating element.

Although the input rotating element and the differential output member of the front and rear wheel power distribution device may integrally be coupled, various forms may be available such as coupling via an interrupting device such as a clutch or coupling via a transmission that increases or decreases speed. The first output rotating element and the second output rotating element may be coupled at least to one or the other of the front and rear wheels regardless of which element is on the front wheel side or the rear wheel side.

Although the shifting portion is disposed on the power transmission path from the first output rotating element to the first wheel in the fourth aspect of the present invention, the shifting portion may be disposed on the power transmission path from the second output rotating element to the second wheel or may be disposed on both of the paths. The shifting portion may be a stepped transmission such as a planetary gear type or a parallel shaft type and may be a stepless (continuously variable) transmission such as a belt type. In the implementation of the second and third aspects of the present invention, such shifting portion is not necessarily needed and different gear ratios can be achieved, for example, by changing the final reduction ratio (differential ratio) of the front-side left and right wheel power distribution device or the rear-side left and right wheel power distribution device. The shifting portion may not necessarily have gear ratios selectable from the speed-decreasing gear ratio greater than one to the speed-increasing gear ratio smaller than one, and only the speed-decreasing gear ratios or the speed-increasing gear ratios may be selectable.

Although the second rotating machine is disposed on the power transmission path between, for example, the first output rotating element and the shifting portion in a power transmittable manner if the shifting portion is disposed on the power transmission path from the first output rotating element to the first wheel as in the fourth aspect of the present invention, the second rotating machine can be disposed on the power transmission path between the shifting portion and the first wheel or can be disposed on the power transmission path on the second wheel side.

Although the first to fourth aspects of the present invention are preferably applied when including the high-speed traveling differential control means of the fifth aspect of the present invention, which performs the differential control causing energy circulation or the acceleration traveling differential control means of the sixth aspect of the present invention, which limits the rotation speed during the regenerative control of the first rotating machine, the first to fourth aspects are applicable if the high-speed traveling differential control means or the acceleration traveling differential control means is not included. Even in such a case, the effects can be acquired such that when the gear ratio on the first wheel side is made smaller than that on the second wheel side and the rotation speed of the differential output member is reduced, the maximum vehicle speed can be increased while avoiding the deterioration of energy efficiency due to energy circulation and that when the gear ratio on the first wheel side is made greater than that on the second wheel side and the rotation speed of the differential output member is increased, the rotation speed of the drive force source such as an engine coupled to the differential input member can be increased to improve the power performance during acceleration, etc.

### Embodiments

Embodiments of the present invention will now be described in detail with reference to the drawings.

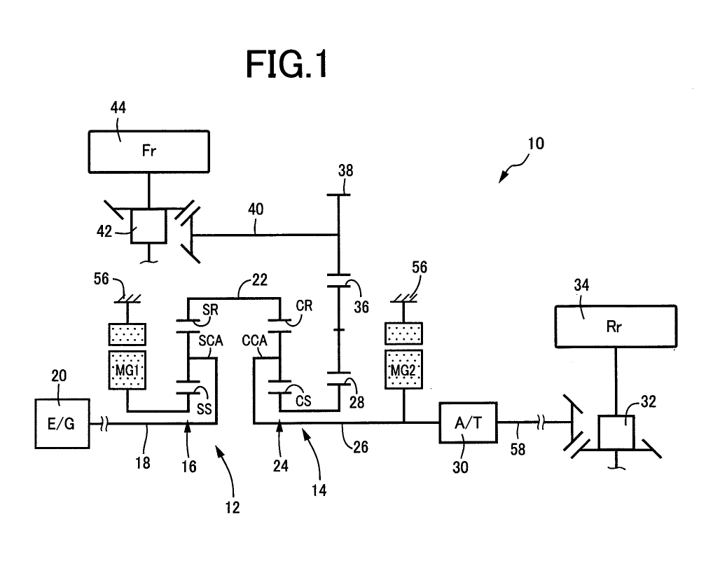

FIG. 1 is a schematic for explaining a power transmission device 10 of a hybrid front and rear wheel drive vehicle of an embodiment of the present invention, which includes an electric type differential portion 12 and a front and rear wheel power distribution device 14. The electric type differential portion 12 includes a single pinion type differential planetary gear device 16 as a differential mechanism; a carrier SCA of the differential planetary gear device 16 is coupled via a differential input shaft 18, etc., as a differential input member to an engine 20 used as a main drive power source; a sun gear SS is coupled to a first motor generator MG1 as a first rotating machine; and a ring gear SR is integrally coupled to a differential output member 22. The engine 20 is an internal combustion engine such as a gasoline engine or a diesel engine and is coupled to the differential input shaft 18 directly or indirectly via a pulsation absorbing damper not shown, etc. The first motor generator MG1 can selectively fulfill functions of both an electric motor and an electric generator and, however, is used mainly as an electric generator in this embodiment.

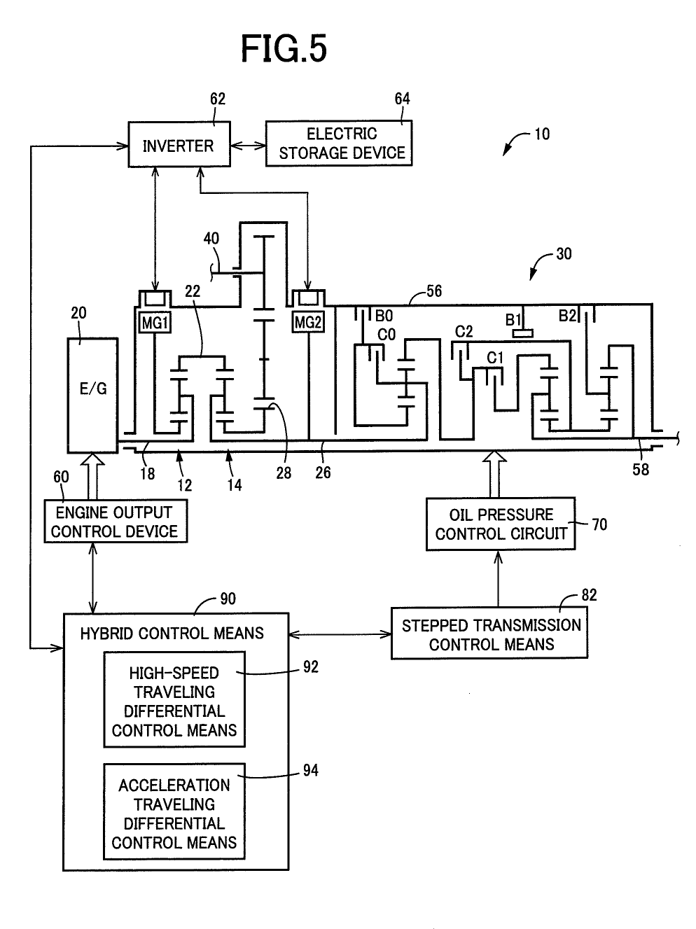

In the differential state of the electric type differential portion 12 configured as described above, a differential action is achieved by enabling the rotation of the three rotating elements, i.e., the sun gear SS, the carrier SCA, and the ring gear SR relative to each other in the differential planetary gear device 16 and, therefore, the output of the engine 20 is distributed to the first motor generator MG1 and the differential output member 22. When a portion of the distributed output of the engine 20 rotationally drives the first motor generator MG1, electric energy is generated through the regenerative control (generation control) of the first motor generator MG1; the electric energy is used for the power running control of the second motor generator MG2 disposed on the power transmission path on the rear wheel side; and excess electric energy is used to charge an electric storage device 64 (see FIG. 5) that is a battery. The electric type differential portion 12 is allowed to function as an electric differential device and achieve a so-called continuously variable transmission state (electric CVT state) and the rotation of the differential output member 22 is continuously varied regardless of a predetermined rotation of the engine 20 depending on the rotation speed of the first motor generator MG1. Therefore, the electric type differential portion 12 functions as an electric stepless transmission with a gear ratio γS (=rotation speed of the differential input shaft 18/rotation speed of the differential output member 22) continuously varied from a minimum value γSmin to a maximum value γSmax. By controlling the operation state of the first motor generator MG1 coupled to the electric type differential portion 12 in a power transmittable manner as described above, the differential state is controlled between the rotation speed of the differential input shaft 18, i.e., the engine rotation speed NE and the rotation speed of the differential output member 22.

The front and rear wheel power distribution device 14 is made up mainly of a single pinion type distribution planetary gear device 24 acting as a differential mechanism, and a ring gear CR of the distribution planetary gear device 24 is an input rotating element and is integrally coupled to the differential output member 22. A carrier CCA is integrally coupled to a rear-wheel output shaft 26 and a sun gear CS is integrally coupled to a front-wheel output gear 28. The rear-wheel output shaft 26 is operatively coupled to left and right rear wheels 34 via an automatic transmission 30 and a rear-side left and right wheel power distribution device 32, and a second motor generator MG2 is coupled to the power transmission path between the automatic transmission 30 and the carrier CCA in a power transmittable manner. The second motor generator MG2 can selectively fulfill functions of both an electric motor and an electric generator and, however, is used mainly as an electric motor in this embodiment to rotationally drive the rear wheels 34 for the motor traveling and to add an assist torque during the traveling using the engine 20 as a drive power source. The front-wheel output gear 28 is operatively coupled to left and right front wheels 44 via a counter gear 36, a driven gear 38, a transmission shaft 40, and a front-side left and right wheel power distribution device 42. Since the electric type differential portion 12, the front and rear wheel power distribution device 14, the first motor generator MG1, and the second motor generator MG2 are configured substantially symmetrically relative to the shaft center thereof, the lower half is not depicted in the schematic of FIG. 1.

Therefore, the front and rear wheel drive vehicle of this embodiment is a four-wheel-drive vehicle based on an FR (front-engine rear-drive) vehicle and the planetary gear type front and rear wheel power distribution device 14 is disposed between the electric type differential portion 12 and the second motor generator MG2 so as to transmit the power from the electric type differential portion 12 to the front wheels 44.

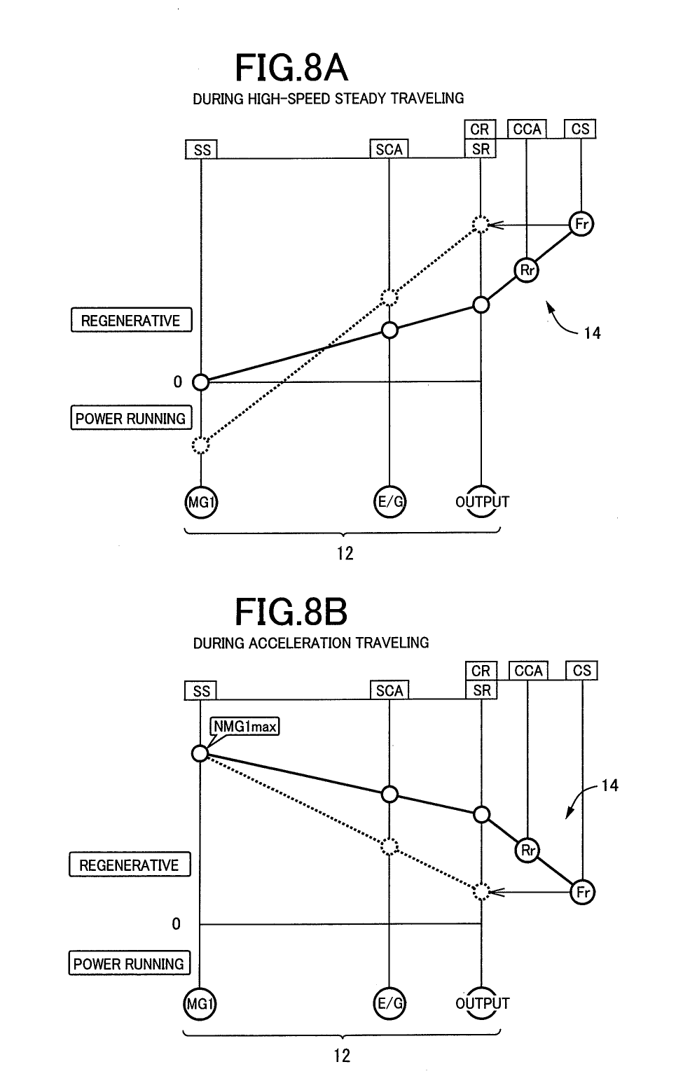

FIGS. 8A and 8B are collinear diagrams capable of representing on straight lines the rotation speeds of the three rotating elements (SS, SCA, SR) of the electric type differential portion 12 and also depict collinear diagrams of the front and rear wheel power distribution device 14. In the electric type differential portion 12 that achieves the differential action with the single pinion type differential planetary gear device 16, a ratio of intervals among the rotating elements (SS, SCA, SR) is determined depending on a gear ratio ρS of the differential planetary gear device 16 and, in the front and rear wheel power distribution device 14 that achieves the differential action with the single pinion type distribution planetary gear device 24, a ratio of intervals among the rotating elements (CS, CCA, CR) is determined depending on a gear ratio ρC of the distribution planetary gear device 24. In this embodiment, the engine 20 is coupled to the carrier SCA located in the middle on the collinear diagram among the three rotating elements (SS, SCA, SR) in the electric type differential portion 12; the differential output member 22 is coupled to the ring gear SR on the side of a narrower interval from the carrier SCA; and the first motor generator MG1 is coupled to the sun gear SS on the side of a wider interval. Among the three rotating elements (CS, CCA, CR) of the front and rear wheel power distribution device 14, the carrier CCA located in the middle on the collinear diagram is a first output rotating element and is operatively coupled via the rear-wheel output shaft 26 to the rear wheels 34 in this embodiment; the ring gear CR on the side of a smaller interval is an input rotating element and is integrally coupled to the ring gear SR of the electric type differential portion 12; and the sun gear CS on the opposite side is a second output rotating element and is operatively coupled to the front wheels 44 via the front-wheel output gear 28. The rear wheel 34 corresponds to a first wheel that is one of the front and rear wheels and the front wheel 44 corresponds to a second wheel that is the other of the front and rear wheels. The gear ratio ρS of the differential planetary gear device 16 and the gear ratio ρC of the distribution planetary gear device 24 are appropriately determined in consideration of a torque distribution ratio etc.

The front-wheel output gear 28 and the driven gear 38 have the same number of teeth and are rotatable at a constant speed in the same direction; the final reduction ratio (differential ratio) it on the rear wheel 34 side is equivalent to the final reduction ratio (differential ratio) if on the front wheel 44 side; and in the case of a gear ratio γT=1 in the automatic transmission 30, the gear ratios γr and γf from the front and rear wheel power distribution device 14 to the rear wheel 34 and the front wheel 44 are equivalent to each other. As a result, during straight traveling, the carrier CCA and the sun gear CS are rotated at the same rotation speed and the front and rear wheel power distribution device 14 is substantially integrally rotated and, if a difference in rotation speed is generated between the front and rear wheels at the time of turning etc., the carrier CCA and the sun gear CS are allowed to differentially rotated. On the other hand, at the time of the speed-increasing gear ratio when the gear ratio γT of the automatic transmission 30 is smaller than one, since the gear ratio γr from the front and rear wheel power distribution device 14 to the rear wheel 34 becomes smaller than the gear ratio γf to the front wheel 44, the carrier CCA on the rear wheel 34 side is rotated slower relative to the sun gear CS on the front wheel 44 side as depicted in FIG. 8A during straight traveling, the rotation speed becomes slower in the ring gear CR that is the input rotating element, i.e., the differential output member 22 and the ring gear SR than the carrier CCA depending on the gear ratio ρC. At the time of the speed-decreasing gear ratio when the gear ratio γT of the automatic transmission 30 is greater than one, since the gear ratio γr from the front and rear wheel power distribution device 14 to the rear wheel 34 becomes greater than the gear ratio γf to the front wheel 44, the carrier CCA on the rear wheel 34 side is rotated faster relative to the sun gear CS on the front wheel 44 side as depicted in FIG. 8B during straight traveling, and the rotation speed becomes faster in the ring gear CR that is the input rotating element, i.e., the differential output member 22 and the ring gear SR than the carrier CCA depending on the gear ratio ρC.

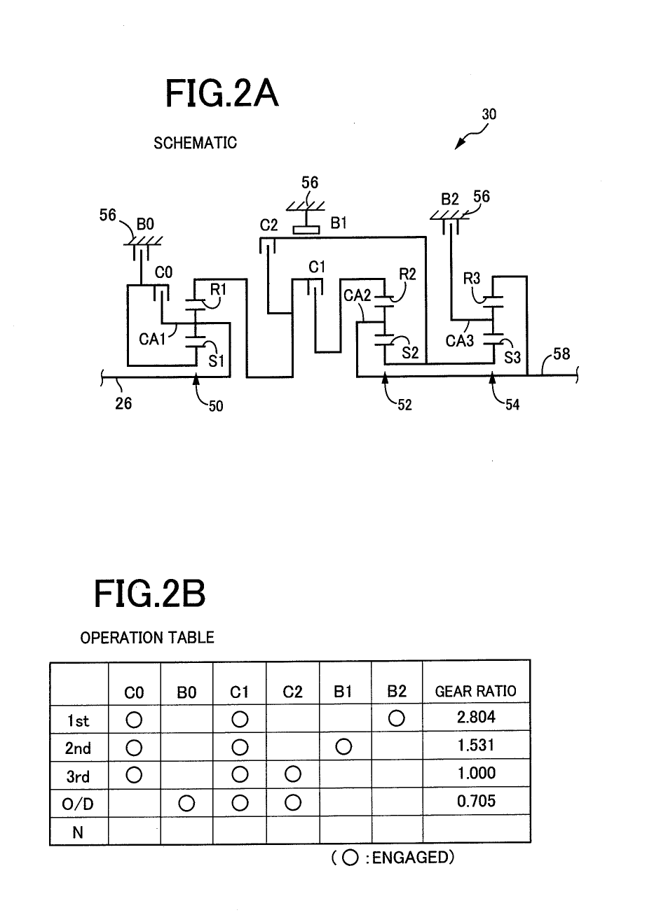

The automatic transmission 30 corresponds to a shifting portion and is a stepped transmission having the gear ratio γT selectable from a speed-decreasing gear ratio greater than one to a speed-increasing gear ratio smaller than one. FIGS. 2A and 2B is a diagram for explaining an example of the automatic transmission 30 as described above and FIG. 2A is a schematic of a planetary gear type transmission including a single pinion type first planetary gear device 50, a single pinion type second planetary gear device 52, and a single pinion type third planetary gear device 54. The first planetary gear device 50 includes a first sun gear S1, a first carrier CA1 that supports a planetary gear in a rotatable and revolvable manner, and a first ring gear R1 engaging with the first sun gear S1 via the planetary gear, and the first carrier CA1 is integrally coupled to the rear-wheel output shaft 26. The first sun gear S1 is selectively coupled to a transmission case (hereinafter, simply a case) 56 via a brake B0 to stop rotation and is selectively coupled to the first carrier CA1 via a clutch C0.

The second planetary gear device 52 includes a second sun gear S2, a second carrier CA2 that supports a planetary gear in a rotatable and revolvable manner, and a second ring gear R2 engaging with the second sun gear S2 via the planetary gear, and the third planetary gear device 54 includes a third sun gear S3, a third carrier CA3 that supports a planetary gear in a rotatable and revolvable manner, and a third ring gear R3 engaging with the third sun gear S3 via the planetary gear. The second ring gear R2 is selectively coupled to the first ring gear R1 via a clutch C1. The second sun gear S2 and the third sun gear S3 are integrally coupled to each other, selectively coupled to the first ring gear R1 via a clutch C2, and selectively coupled to the case 56 via a brake B1 to stop rotation. The third carrier CA3 is selectively coupled to the case 56 via a brake B2 to stop rotation. The second carrier CA2 and the third ring gear R3 are integrally coupled to each other and are integrally coupled to an AT output shaft 58 to output rotation after shifting gears. Since the automatic transmission 30 is also configured substantially symmetrically relative to the shaft center, the lower half is not depicted in the schematic of FIG. 2A.

The clutches C0, C1, C2, and the brakes B0, B1, B2 (hereinafter, simply, clutches C and brakes B if not particularly distinguished) are hydraulic friction engagement devices and are made up of a wet multi-plate type with a hydraulic actuator pressing a plurality of friction plates overlapped with each other or as a band brake with a hydraulic actuator fastening one end of one or two bands wrapped around an outer peripheral surface of a rotating drum, or the like, integrally coupling members on the both sides of the devices interposed therebetween. These clutches C and brakes B are selectively engaged and released as depicted in an operation table of FIG. 2B to establish four forward gear stages from a first speed gear stage “1st” to an O/D gear stage “O/D”, a neutral “N” for interrupting the power transmission. Each of the first speed gear stage “1st” and the second speed gear stage “2nd” has the gear ratio γT (=rotation speed of the rear-wheel output shaft 26/rotation speed of the AT output shaft 58) that is a speed-decreasing gear ratio greater than one and the O/D gear stage “O/D” has the gear ratio γT that is a speed-increasing gear ratio smaller than one. The gear ratio γT described in FIG. 2B is an example in the case of a gear ratio ρ1 of the first planetary gear device 50=0.418, a gear ratio ρ2 of the second planetary gear device 52=0.532, and a gear ratio ρ3 of the third planetary gear device 54=0.418. Backward traveling is performed by rotationally driving the second motor generator MG2 in the inverse rotation direction while the automatic transmission 30 is set to the first speed gear stage “1st”, for example.

Although a stepless transmission is generally made up of the electric type differential portion 12 functioning as a stepless transmission, and the automatic transmission 30 in the power transmission device 10 configured as described above, the electric type differential portion 12 and the automatic transmission 30 can form the state equivalent to a stepped transmission by performing control such that the gear ratio γS of the electric type differential portion 12 is kept constant. Specifically, when the electric type differential portion 12 functions as a stepless transmission and the automatic transmission 30 in series with the electric type differential portion 12 functions as a stepped transmission, the rotation speeds of the differential output member 22 and the rear-wheel output shaft 26 are varied in a stepless manner for at least one gear stage G of the automatic transmission 30, and a stepless gear ratio width is acquired in the gear stage G. A total gear ratio of the power transmission device 10 is acquired for each gear stage by performing control such that the gear ratio γS of the electric type differential portion 12 is kept constant and by selectively performing engagement operation of the clutches C and the brakes B to establish any one of the first speed gear stage “1st” to the O/D gear stage “O/D”. For example, if the rotation speed NMG1 of the first motor generator MG1 is controlled such that the gear ratio γS of the electric type differential portion 12 is fixed to “1”, a total gear ratio of the electric type differential portion 12 and the automatic transmission 30 is the same as the gear ratio γT of each gear stage of the first speed gear stage “1st” to the O/D gear stage “O/D” of the automatic transmission 30.

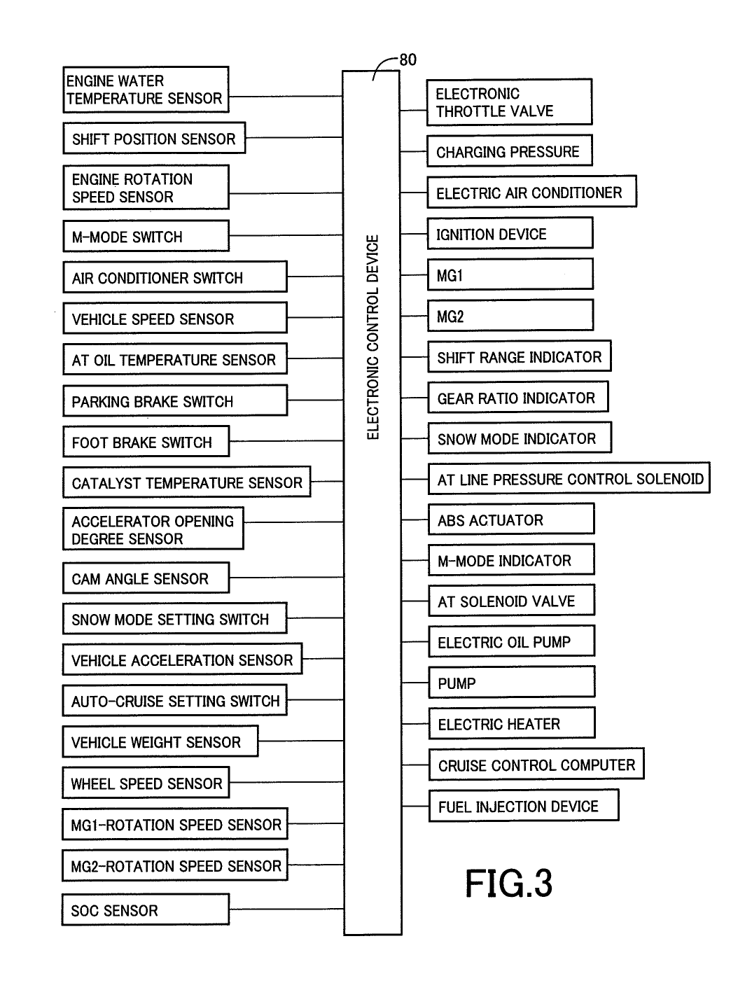

FIG. 3 exemplarily illustrates signals input to an electronic control device 80 for controlling the power transmission device 10 of this embodiment and signals output from the electronic control device 80. The electronic control device 80 includes a so-called microcomputer made up of CPU, ROM, RAM, I/O interface, etc., and executes signal processes in accordance with programs stored in advance in the ROM, while utilizing a temporary storage function of the RAM, to execute the hybrid drive control related to the engine 20, the first motor generator MG1, and the second motor generator MG2 and the shift control of the automatic transmission 30 and the like.

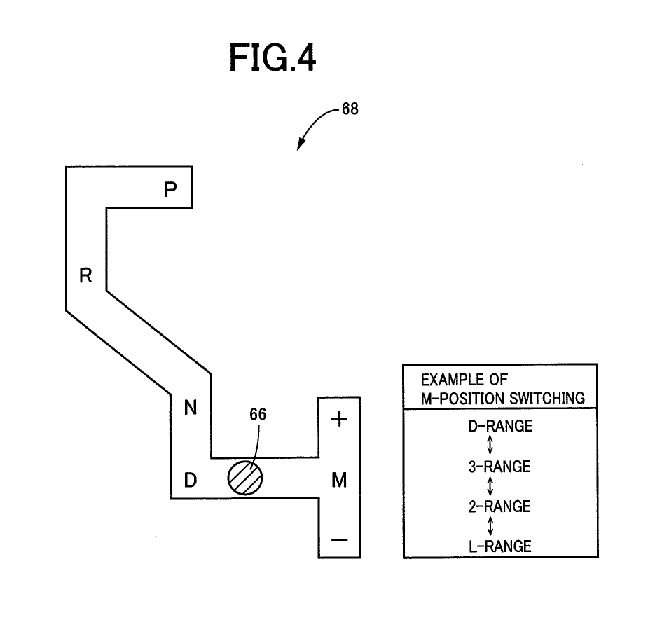

The electronic control device 80 is supplied, from sensors, switches, etc., as depicted in FIG. 3, with a signal indicative of an engine water temperature TEMP_{W}, signals indicative of a shift position P_{SH} of a shift lever 66 (see FIG. 4) and the number of operations at an “M” position, a signal indicative of an engine rotation speed NE that is the rotation speed of the engine 20, a signal giving a command for an M-mode (manual shift traveling mode), a signal indicative of operation of an air conditioner, a signal indicative of a vehicle speed V corresponding to the rotation speed N_{OUT} of the AT output shaft 58, a signal indicative of an operating oil temperature T_{OIL} of the automatic transmission 30, a signal indicative of a parking brake operation, a signal indicative of a foot brake operation, a signal indicative of a catalyst temperature, a signal indicative of an accelerator operation amount (opening degree) Acc that is an amount of an accelerator pedal operation corresponding to an output request amount of a driver, a signal indicative of a cam angle, a signal indicative of a snow mode setup, a signal indicative of longitudinal acceleration G of a vehicle, a signal indicative of auto-cruise travelling, a signal indicative of a weight of a vehicle (vehicle weight), a signal indicative of a wheel speed for each of wheels, a signal indicative of a rotation speed NMG1 of the first motor generator MG1, a signal indicative of a rotation speed NMG2 of the second motor generator MG2, a signal indicative of an electric charge amount (remaining amount) SOC of the electric storage device 64 and the like.

The electronic control device 80 outputs control signals to an engine output control device 60 (see FIG. 5) that controls engine output, for example, a drive signal to a throttle actuator that operates a throttle valve opening degree θ_{TH} of an electronic throttle valve disposed in an induction pipe of the engine 20, a fuel supply amount signal that controls a fuel supply amount into the induction pipe or cylinders of the engine 20 from a fuel injection device, an ignition signal that gives a command for the timing of the ignition of the engine 20 by an ignition device, a charging pressure adjusting signal for adjusting a charging pressure, etc. The electronic control device 80 also outputs an electric air conditioner drive signal for activating an electric air conditioner; command signals that gives commands for the operation of the electric motor generator MG1 and the second motor generator MG2; a shift position (operational position) display signal for activating a shift indictor; a gear ratio display signal for displaying a gear ratio; a snow mode display signal for displaying that the snow mode is in operation; an ABS activation signal for activating an ABS actuator that prevents wheels from slipping at the time of braking; an M-mode display signal for displaying that the M-mode is selected; a valve command signal for activating an electromagnetic valve (linear solenoid valve) included in a hydraulic control circuit 70 (see FIG. 5) so as to control the hydraulic actuator of the hydraulic friction engagement devices of the electric type differential portion 12 and the automatic transmission 30; a signal for regulating a line oil pressure PL with a regulator valve (pressure regulating valve) disposed in the hydraulic control circuit 70; a drive command signal for activating an electric oil pump that is an oil pressure source of an original pressure for regulating the line oil pressure PL; a signal for driving an electric heater; a signal to a computer for controlling the cruise control, etc.

FIG. 4 is a diagram of an example of a shift operation device 68 as a switching device that switches a plurality of types of shift positions P_{SH} through artificial manipulation. The shift operation device 68 is disposed next to a driver's seat, for example, and includes the shift lever 66 operated so as to select a plurality of types of shift positions P_{SH}. The shift lever 66 is arranged to be manually operated to a “P (parking)” position for parking used for being in a neutral state, i.e., neutral state with the power transmission path interrupted in the power transmission device 10 and for locking the AT output shaft 58 of the automatic transmission 30; an “R (reverse)” position for backward traveling; an “N (neutral)” position for being in the neutral state with the power transmission path interrupted in the power transmission device 10; a “D (drive)” position for achieving an automatic transmission mode (D-range) to execute the automatic transmission control in a stepless gear ratio width of the electric type differential portion 12 and all the forward gear stages “1st” to “O/D” of the automatic transmission 30; or an “M (manual)” position for achieving a manual transmission traveling mode (M-mode) to set a so-called shift range that limits shift stages on the high-speed side in the automatic transmission 30.

The “M” position is disposed, for example, at the same position as the “D” position in the longitudinal direction of a vehicle adjacently along the width direction of the vehicle and when the shift lever 66 is operated to the “M” position, any one of four shift ranges from D-range to L-range is selected depending on the operation of the shift lever 66. Specifically, the “M” position is provided with an upshift position “+” and a downshift position “−” along the longitudinal direction of a vehicle and each time the shift lever 66 is operated to the upshift position “+” or the downshift position “−”, the shift range goes up or down one by one. The four shift ranges from D-range to L-range are shift ranges of a plurality of types having different gear ratios on the high-speed side (the side of smaller gear ratios) in a variation range where the automatic transmission control of the power transmission device 10 is available; specifically, the high-speed-side gear stages available for the shifting of the automatic transmission 30 is reduced one by one; and although the highest speed gear stage is the O/D gear stage “O/D” in the D-range, the highest speed gear stage is set to the third speed gear stage “3rd” in a 3-range, to the second speed gear stage “2nd” in a 2-range, and to the first speed gear stage “1st” in an L-range. The shift lever 66 is automatically returned to the “M” position from the upshift position “+” and the downshift position “−” by a biasing means such as a spring.

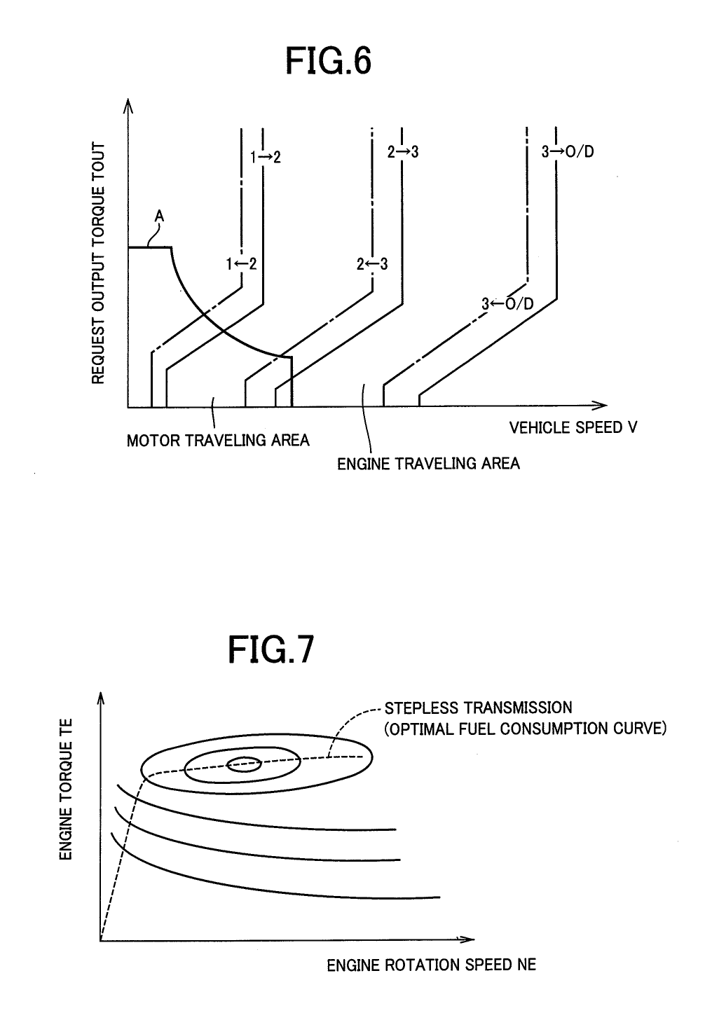

FIG. 5 is a functional block line diagram for explaining a main portion of the control function of the electronic control device 80, and a stepped transmission control means 82 and a hybrid control means 90 are functionally included. The stepped transmission control means 82 determines whether the shift of the automatic transmission 30 should be executed based on the vehicle state indicated by the actual vehicle speed V and request output torque TOUT in accordance with a preliminarily stored shifting line diagram depicted in FIG. 6, i.e., a relationship (a shifting line diagram, a shifting map) having upshift lines (solid lines) and downshift lines (dashed lines) preliminarily stored using the vehicle speed V and the request output torque TOUT (accelerator operation amount Acc, etc.) as parameters, i.e., determines the gear stage to be set by the shift of the automatic transmission 30 and executes the automatic transmission control of the automatic transmission 30 so as to acquire the determined gear stage.

In this case, the stepped transmission control means 82 outputs to the hydraulic control circuit 70 a command (a shift output command, a hydraulic pressure command) for engaging and releasing the hydraulic friction engagement devices (the clutches C and the brakes B) involved in the shift of the automatic transmission 30, i.e., a command for executing the clutch-to-clutch shift by releasing the release-side friction engagement devices involved in the shift of the automatic transmission 30 and by engaging the engagement-side friction engagement devices so as to establish a predetermined gear stage in accordance with the engagement table depicted in FIG. 2B, for example. The hydraulic control circuit 70 changes the engagement pressure of the hydraulic friction engagement devices involved in the shift with a linear solenoid valve, etc., in accordance with a predetermined hydraulic change pattern as instructed by the command to release the release-side friction engagement devices and engage the engagement-side friction engagement devices for executing the shift of the automatic transmission 30.

On the other hand, the hybrid control means 90 drives the engine 20 to operate in an efficient operation range, controls the drive force distribution between the engine 20 and the second motor generator MG2, and changes a reaction force due to the electric generation by the first motor generator MG1 to the optimum state to control the gear ratio γS of the electric type differential portion 12 acting as an electric stepless transmission. Therefore, for a traveling vehicle speed V at a time point, a target (request) output of a vehicle is calculated from the accelerator opening degree Acc that is an output request amount of a driver and the vehicle speed V, and a necessary total target output is calculated from the target output and a charge request value of the vehicle. A target engine output is then calculated such that the total target output is acquired in consideration of a transmission loss, loads of accessories, an assist torque of the second motor generator MG2, etc., to control the engine 20 while an amount of the electric generation of the first motor generator MG1 is controlled so as to achieve the engine rotation speed NE and the engine torque TE enabling acquisition of the target engine output.

The electric type differential portion 12 is driven to function as an electric stepless transmission to match the engine rotation speed NE determined for operating the engine 20 in an efficient operation range with the rotation speed of the differential output member 22 determined from the vehicle speed V and the shift stages of the automatic transmission 30, i.e., the rotation speed of the ring gear SR. Therefore, the hybrid control means 90 determines a target value of the total gear ratio of the power transmission device 10 depending on the vehicle speed V and controls the gear ratio γS of the electric type differential portion 12 in consideration of the gear stages of the automatic transmission 30 to acquire the target value such that the engine 20 is operated along an optimal fuel consumption curve, based on the optimal fuel consumption curve (fuel consumption map, relationship) of the engine 20 represented by a broken line of FIG. 7 empirically obtained and stored in advance so as to satisfy both the drivability and the fuel consumption property during travelling with stepless transmission in the two-dimensional coordinates made up of the engine rotation speed NE and the output torque (engine torque) TE of the engine 20.

In this case, the hybrid control means 90 supplies the electric energy generated by the first motor generator MG1 to the electric storage device 64 and the second motor generator MG2 via the inverter 62 and, as a result, a main portion of the power of the engine 20 is mechanically transmitted to the differential output member 22 while a portion of the power of the engine 20 is consumed for the electric generation of the first motor generator MG1 and converted into electric energy. The electric energy is supplied through the inverter 62 to the second motor generator MG2 and the second motor generator MG2 is driven to add the torque thereof to the rear-wheel output shaft 26. The equipments related to the electric energy from the generation to the consumption by the second motor generator MG2 make up an electric path from the conversion of a portion of the power of the engine 20 into an electric energy to the conversion of the electric energy into a mechanical energy. During normal steady traveling, as depicted in a solid line of FIG. 8A, the rotation speed NMG1 of the first motor generator MG1 is maintained to substantially zero or is rotated in the positive rotation direction same as the engine rotation direction depending on the vehicle speed V to generate electric energy through the regenerative control and to accept the reaction force when the differential output member 22 (ring gear SR) is rotationally driven in the positive rotation direction by the engine 20.

The hybrid control means 90 controls the first motor generator rotation speed NMG1 with the electric CVT function of the electric type differential portion 12 such that the engine rotation speed NE is maintained substantially constant or controlled at an arbitrary rotation speed regardless of whether a vehicle is stopped or traveling.

The hybrid control means 90 functionally includes an engine output control means that outputs commands separately or in combination to the engine output control device 60 to control opening/closing of the electronic throttle valve with the throttle actuator for throttle control, to control a fuel injection amount and an injection timing of the fuel injection device for the fuel injection control, and to control the timing of the ignition by the ignition device such as an igniter for the ignition timing control, executing the output control of the engine 20 to generate necessary engine output. For example, the throttle actuator is basically driven based on the accelerator operation amount Acc in accordance with a preliminarily stored relationship not depicted to execute the throttle control such that the throttle valve opening degree θ_{TH} is increased as the accelerator operation amount Acc increases.

The hybrid control means 90 can achieve the motor traveling with the electric CVT function (differential action) of the electric type differential portion 12 regardless of whether the engine 20 is stopped or in the idle state. For example, the engine 20 is stopped or put into the idle state and the motor traveling is performed by using only the second motor generator MG2 as a drive force source in a relatively lower output torque zone, i.e., a lower engine torque zone generally considered as having poor engine efficiency as compared to a higher torque zone, or in a relatively lower vehicle speed zone of the vehicle speed V, i.e., a lower load zone. For example, in FIG. 6, a predetermined motor traveling area is located on the side closer to the original point than a solid line A, i.e., the lower torque side or the lower vehicle speed side. During the motor traveling, only the rear wheels 34 are driven for the rear-wheel-drive travelling. To suppress the drag of the engine 20 and improve the fuel consumption while the engine 20 is stopped, it is desirable that, for example, the first motor generator MG1 is put into a no-load state and is allowed to idle so as to maintain the engine rotation speed NE at zero or substantially zero with the electric CVT function (differential action) of the electric type differential portion 12. Even in the motor traveling area, the engine 20 is operated as needed at the time of predetermined acceleration, etc., for traveling using both the engine 20 and the second motor generator MG2 as the drive force sources. The engine 20 is put into the operating state as needed for charging of the electric storage device 64, warm-up, etc.

The hybrid control means 90 can perform so-called torque assist for complementing the power of the engine 20, even during engine traveling using the engine 20 as the drive force source, by supplying the electric energy from the first motor generator MG1 and/or the electric energy from the electric storage device 64 through the electric path described above to the second motor generator MG2 and by driving the second motor generator MG2 to apply a torque to the rear wheels 34. For example, at the time of acceleration traveling when the accelerator pedal is deeply depressed or on a climbing road, the second motor generator MG2 is subjected to the power running control to perform the torque assist. Although the engine traveling area for performing the engine traveling is located on the outside of the solid line A in FIG. 6, i.e., the higher torque side or the higher vehicle speed side, the torque assist by the second motor generator MG2 is performed as needed. The entire area may be defined as the engine traveling area without providing the motor traveling area indicated by the solid line A of FIG. 6 to perform the torque assist by the second motor generator MG2 with the electric energy acquired through the regenerative control of the first motor generator MG1.

The hybrid control means 90 can allow the first motor generator MG1 to freely rotate, i.e., idle in the no-load state to achieve the state in which the electric type differential portion 12 is unable to transmit a torque i.e., the state equivalent to the state with the power transmission path interrupted in the electric type differential portion 12, and in which the output from the electric type differential portion 12 is not generated. Therefore, the hybrid control means 90 can put the first motor generator MG1 into the no-load state to put the electric type differential portion 12 into the neutral state (neutral state) with the power transmission path electrically interrupted.

The hybrid control means 90 has a function as a regenerative control means that operates the second motor generator MG2 as an electric generator through the regenerative control thereof when the second motor generator MG2 is rotationally driven by a kinetic energy of a vehicle, i.e., a reverse drive force input from the rear wheels 34 and that charges the electric storage device 64 through the inverter 62 with the electric energy to improve the fuel consumption during the inertia traveling (during coasting) when the acceleration is turned off and at the time of braking by the foot brake or the like. This regenerative control is controlled to achieve a regenerative amount determined based on an electric charge amount SOC of the electric storage device 64 and the braking force distribution of a braking force from a hydraulics brake for acquiring a braking force corresponding to a brake pedal operation amount.

As depicted in the functional block line diagram of FIG. 5, the hybrid control means 90 functionally includes a high-speed traveling differential control means 92 and an acceleration traveling differential control means 94. The high-speed traveling differential control means 92 rotationally drives the first motor generator MG1 through the power running control in the inverse rotation direction as needed, for example, as indicated by a dot-line in FIGS. 8A and 8B to maintain the engine rotation speed NE at a predetermined value if the rotation speed of the differential output member 22, i.e., the ring gear SR is increased as the vehicle speed V increases. Although the electric energy necessary for the power running control of the first motor generator MG1 is recovered by the regenerative control of the second motor generator MG2 in this case, the power transmitted from the engine 20 to the second motor generator MG2 is converted into electric energy, and the electric energy is used for performing the power running control of the first motor generator MG1 of the electric type differential portion 12 located on the upstream and, therefore, the energy circulation occurs therebetween, deteriorating energy efficiency. Although the engine rotation speed NE is determined by comprehensively judging the deterioration of energy efficiency due to this energy circulation, the fuel consumption characteristics of the engine 20, etc., the high-speed traveling differential control is inevitable to perform the power running control of the first motor generator MG1 in the inverse rotation direction when the vehicle speed V becomes equal to or greater than a predetermined value.

Concerning this case, in the front and rear wheel power distribution device 14 of this embodiment, the ring gear CR of the single pinion type distribution planetary gear device 24 is coupled as an input rotation element to the differential output member 22, and the carrier CCA is coupled to the rear-wheel output shaft 26 for output to the rear wheel side disposed with the automatic transmission 30. Therefore, if the gear stage of the automatic transmission 30 is the O/D gear stage “O/D” having the gear ratio γT<1 and the gear ratio γr from the front and rear wheel power distribution device 14 to the rear wheel 34 becomes smaller than the gear ratio γf to the front wheel 44, the carrier CCA on the rear wheel 34 side rotates slower relative to the sun gear CS on the front wheel 44 side as depicted in FIG. 8A, and the rotation speed of each of the ring gear CR that is the input rotation element, i.e., the differential output member 22 and the ring gear SR becomes slower than that of the carrier CCA depending on the gear ratio ρC. When the rotation speed of the differential output member 22 is reduced in this way, if the engine rotation speed NE is the same, a change in the rotation of the first motor generator MG1 in the inverse rotation direction is suppressed correspondingly to the reduction, and the frequency of execution is reduced in the high-speed traveling differential control for performing the power running control to rotationally drive the first motor generator MG1 in the inverse rotation direction depending on the rotation speed of the differential output member 22 and for performing the regenerative control of the second motor generator MG2 to recover electric energy. Alternatively, even if the high-speed traveling differential control is performed, the rotation speed in the inverse rotation direction is reduced in the power running control of the first motor generator MG1. Therefore, the energy circulation becomes difficult to occur or an energy loss due to the energy circulation is reduced, resulting in the improvement of the energy efficiency.

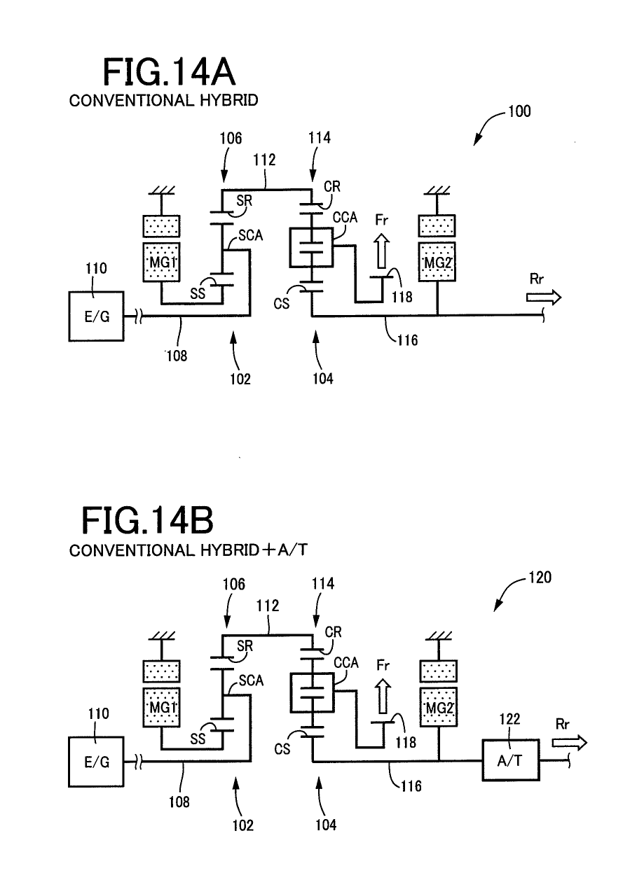

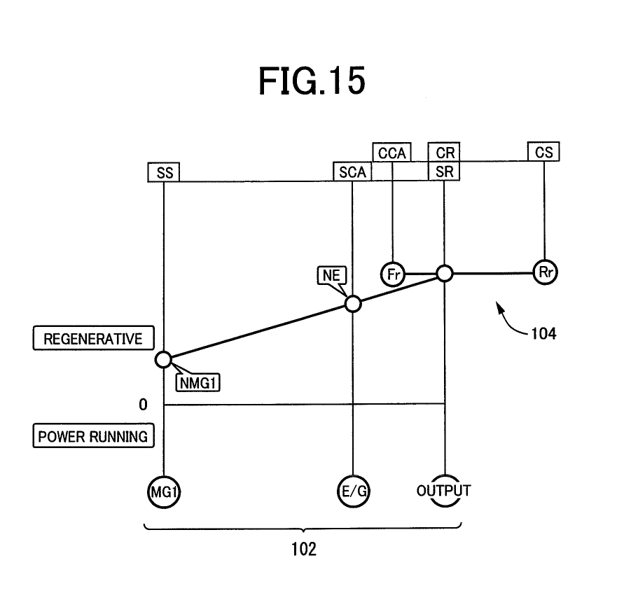

A solid line of FIG. 8A represents the case that the energy circulation can be avoided since the rotation speed NMG1 of the first motor generator MG1 can be maintained at substantially zero while the engine rotation speed NE is retained at a predetermined value by reducing the rotation speed of the differential output member 22, i.e., the ring gear SR. A broken line represents the case of the conventional power transmission device 100 depicted in FIG. 14A and, since the increase in the engine rotation speed NE is not sufficient, the high-speed traveling differential control is executed to perform the power running control of the first motor generator MG1 in the inverse rotation direction because of the comprehensive judgment on the energy efficiency, resulting in the deterioration of the energy efficiency due to the energy circulation.

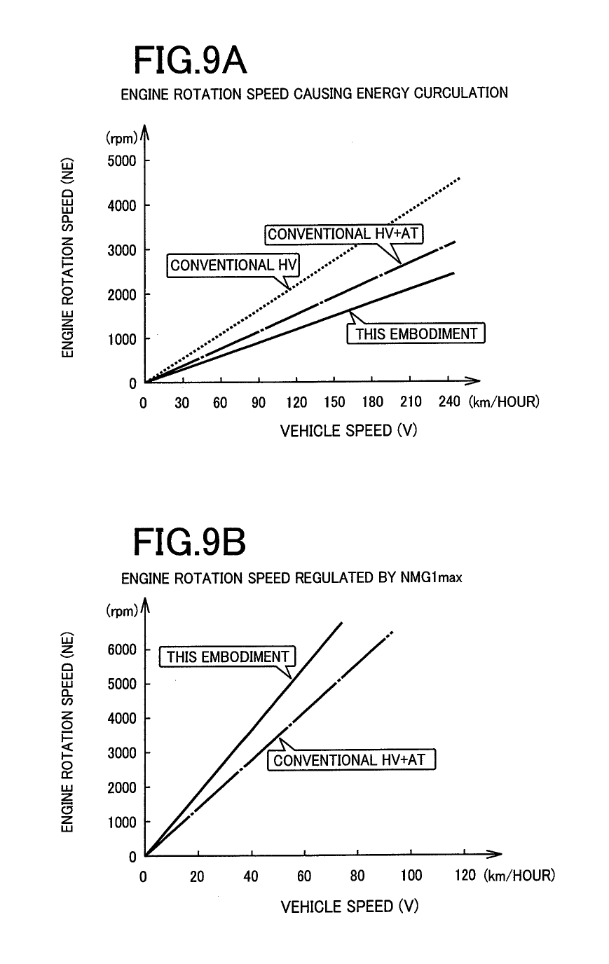

In FIG. 9A, the engine rotation speed NE causing the energy circulation is compared among this embodiment, the conventional hybrid depicted in FIG. 14A, and the conventional hybrid depicted in FIG. 14B equipped with the automatic transmission 122 (which is the same as the automatic transmission 30 of this embodiment). Although the energy circulation occurs and the first motor generator MG1 is rotationally driven in the inverse rotation direction on the right side relative to a graph indicated by a straight line, i.e., at a higher vehicle speed in each case, the area causing the energy circulation is considerably narrowed and the energy efficiency is correspondingly improved according to this embodiment, as compared to the conventional hybrid and the conventional hybrid+AT.

The acceleration traveling differential control means 94 executes the acceleration traveling differential control to perform the regenerative control of the first motor generator MG1 to recover electric energy during acceleration traveling and to limit the rotation speed NMG1 of the first motor generator MG1 at the time of the regenerative control in accordance with a predetermined regenerative condition. The regenerative condition is prescribed so as to avoid overcharge of the electric storage device 64 if the electric energy acquired by the first motor generator MG1 is greater than the electric energy consumed by the second motor generator MG2, for example, or prescribed considering an allowable maximum charge amount (power) of the electric storage device 64 itself, etc., and an allowable maximum rotation speed NMG1max is set in advance based on the electric charge amount SOC of the electric storage device 64, etc. If the rotation speed NMG1 of the first motor generator MG1 is limited by the allowable maximum rotation speed NMG1max in this way, the engine rotation speed NE is limited depending on the vehicle speed V, i.e., the rotation speed of the differential output member 22 and desired output may not be acquired.

In this case, in the front and rear wheel power distribution device 14 of this embodiment, the ring gear CR of the single pinion type distribution planetary gear device 24 is coupled as an input rotation element to the differential output member 22, and the carrier CCA is coupled to the rear-wheel output shaft 26 for output to the rear wheel side disposed with the automatic transmission 30. Therefore, if the gear stage of the automatic transmission 30 is the first speed gear stage “1st” or the second speed gear stage “2nd” having the gear ratio γT>1 and the gear ratio γr from the front and rear wheel power distribution device 14 to the rear wheel 34 becomes greater than the gear ratio γf to the front wheel 44, the carrier CCA on the rear wheel 34 side rotates faster relative to the sun gear CS on the front wheel 44 side as depicted in FIG. 8B, and the rotation speed of each of the ring gear CR that is the input rotation element, i.e., the differential output member 22 and the ring gear SR becomes faster than that of the carrier CCA depending on the gear ratio ρC. When the rotation speed of the differential output member 22 is increased in this way, the restriction on increase in the engine rotation speed NE due to the rotation speed limitation of the first motor generator MG1 is alleviated correspondingly to the increase of the rotation speed of the differential output member 22, and excellent power performance (power) can be acquired by increasing the engine rotation speed NE.

A solid line of FIG. 8B represents the case that increasing the rotation speed of the differential output member 22, i.e., the ring gear SR correspondingly increases the engine rotation speed NE when the first motor generator rotation speed NMG1 is limited to the allowable maximum rotation speed NMG1max. A broken line represents the case of the conventional power transmission device 100 depicted in FIG. 14A and, since the rotation speed of the differential output member 22 is the same as the rotation speed of the front-wheel output gear 28 and the engine rotation speed NE is limited lower by the rotation speed of the differential output member 22, desired output cannot be acquired.

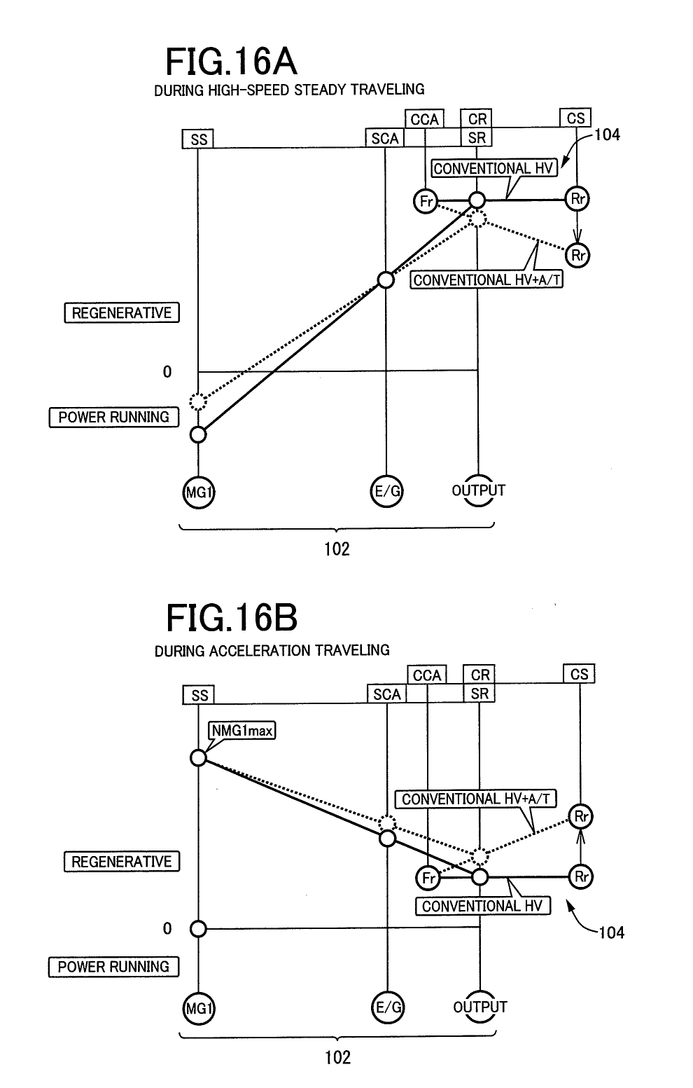

FIG. 9B depicts the relationship of the vehicle speed V and the engine rotation speed NE compared between this embodiment and the conventional hybrid depicted in FIG. 14B equipped with the automatic transmission 122 (which is the same as the automatic transmission 30 of this embodiment) when the first motor generator rotation speed NMG1 is limited to the predetermined allowable maximum rotation speed NMG1max for prevention of overcharge of the electric storage device 64 during acceleration at start-up. The gear stages of the automatic transmissions 30, 122 are both fixed to the first speed gear stage “1st”. This embodiment can increase the engine rotation speed NE higher than the conventional hybrid+AT, thereby acquiring excellent power performance (power). In the case of the conventional hybrid depicted in FIG. 14A not equipped with an automatic transmission, since the rotation speed of the differential output member 22 for the vehicle speed V is further lower than that of the conventional hybrid+AT (see FIG. 16B), the engine rotation speed NE depicted in FIG. 9B is also further lower than that of the conventional hybrid+AT and sufficient power performance (power) cannot be acquired.

The power transmission device 10 of a front and rear wheel drive vehicle of this embodiment is configured such that an input rotation element, a first output rotation element, and a second output rotation element are arranged in series from one end to the other end on a collinear diagram capable of representing the rotation speeds of the three rotation elements (CS, CCA, CR) of the front and rear wheel power distribution device 14 on a straight line. Specifically, the ring gear CR of the single pinion type distribution planetary gear device 24 is the input rotation element and is coupled to the differential output member 22; the carrier CCA is the first output rotation element and is coupled to the rear-wheel output shaft 26; and the sun gear CS is the second output rotation element and is coupled to the front-wheel output gear 28. Therefore, if the gear ratio γr from the first output rotation element, i.e., the carrier CCA to the rear wheel 34 is different from the gear ratio γf from the second output rotation element, i.e., the sun gear CS to the front wheel 44 due to the presence/absence of the automatic transmission 30 and a difference between the final reduction ratios if, it of the front and rear wheels, the rotation speed of the input rotation element located at the end among the three rotation elements (CS, CCA, CR), i.e., the ring gear CR is maximized or minimized.

Therefore, if the gear ratios γr and γf are determined such that the rotation speed of the ring gear CR, i.e., the input rotation element is reduced during high-sped traveling, specifically, if the gear ratio γr on the rear wheel side is set smaller than the gear ratio γf on the front wheel side, the rotation speed of the ring gear CR is reduced as well as that of the differential output member 22 (ring gear SR) of the electric type differential portion 12 as depicted in FIG. 8A and a change in the rotation is suppressed in the power running rotation direction of the first motor generator MG1 coupled to the electric type differential portion 12 correspondingly to the reduction of the rotation speed. Therefore, the energy circulation becomes difficult to occur or the rotation speed in the power running rotation direction is lowered and an energy loss due to the energy circulation is reduced, and the energy efficiency is improved. Even if the high-speed traveling differential control means 92 is not included and the first motor generator MG1 is always subjected to the regenerative control without changing the rotation in the inverse rotation direction of the power running control while traveling, the vehicle speed V can be increased while suppressing increase in the rotation of the differential input shaft 18 correspondingly to the reduction of the rotation speed of the differential output member 22, and the maximum vehicle speed can be raised while avoiding the deterioration of the energy efficiency due to the energy circulation.

If the gear ratios γr and γf are determined such that the rotation speed of the ring gear CR, i.e., the input rotation element is increased during acceleration traveling at startup, etc., specifically, if the gear ratio γr on the rear wheel side is set greater than the gear ratio γf on the front wheel side, the rotation speed of the ring gear CR is increased as well as that of the differential output member 22 (ring gear SR) of the electric type differential portion 12 as depicted in FIG. 8B and the restriction on the rotation speed increase of the differential input shaft 18, i.e., the carrier SCA due to the rotation speed limitation of the first motor generator MG1 is alleviated correspondingly to the increase in the rotation speed. Therefore, the rotation speed NE of the engine 20 coupled to the differential input shaft 18 is allowed to increase and the power performance (power) during acceleration can be improved. Even if the acceleration traveling differential control means 94 is not included and the rotation speed of the first motor generator MG1 is not limited at the time of the regenerative control thereof, the rotation speed of the differential input shaft 18 is allowed to increase correspondingly to the increase in the rotation speed of the differential output member 22 and, therefore, the rotation speed of the engine 20 coupled to the differential input shaft 18 can be increased to improve the power performance during acceleration, etc.

In this embodiment, the power transmission path from the front and rear wheel power distribution device 14 to the rear wheel 34 is disposed with the automatic transmission 30 having the gear ratio selectable from a speed-decreasing gear ratio larger than one to a speed-increasing gear ratio smaller than one; if the O/D gear stage “O/D” having the speed-increasing gear ratio is selected during high-speed traveling, the gear ratio γr on the rear wheel side is set smaller than the gear ratio γf on the front wheel side to reduce the rotation speed of the differential output member 22, i.e., the ring gear SR of the electric type differential portion 12; and, on the other hand, if the first speed gear stage “1st” or the second speed gear stage “2nd” having the speed-decreasing gear ratio is selected during acceleration traveling, the gear ratio γr on the rear wheel side is set greater than the gear ratio γf on the front wheel side to increase the rotation speed of the differential output member 22, i.e., the ring gear SR of the electric type differential portion 12. Although the differential control by the high-speed traveling differential control means 92 is performed as needed during high-speed travelling, since the rotation speed of the differential output member 22, i.e., the ring gear SR of the electric type differential portion 12 is reduced, a change in rotation of the first motor generator MG1 in the inverse rotation direction is suppressed and the energy circulation becomes difficult to occur or an energy loss due to the energy circulation is reduced, and the energy efficiency is improved. Although the differential control by the acceleration traveling differential control means 94 is performed as need during acceleration travelling, since the rotation speed of the differential output member 22, i.e., the ring gear SR of the electric type differential portion 12 is increased, the restriction on increase in the rotation speed of the differential input shaft 18 due to the rotation speed limitation of the first motor generator MG1 is alleviated and the rotation speed NE of the engine 20 coupled to the differential input shaft 18 can be increased to acquire excellent power performance (power).

Other embodiments of the present invention will then be described. In the following embodiments, the portions common to the embodiment described above are denoted by the same reference numerals and will not be described in detail.

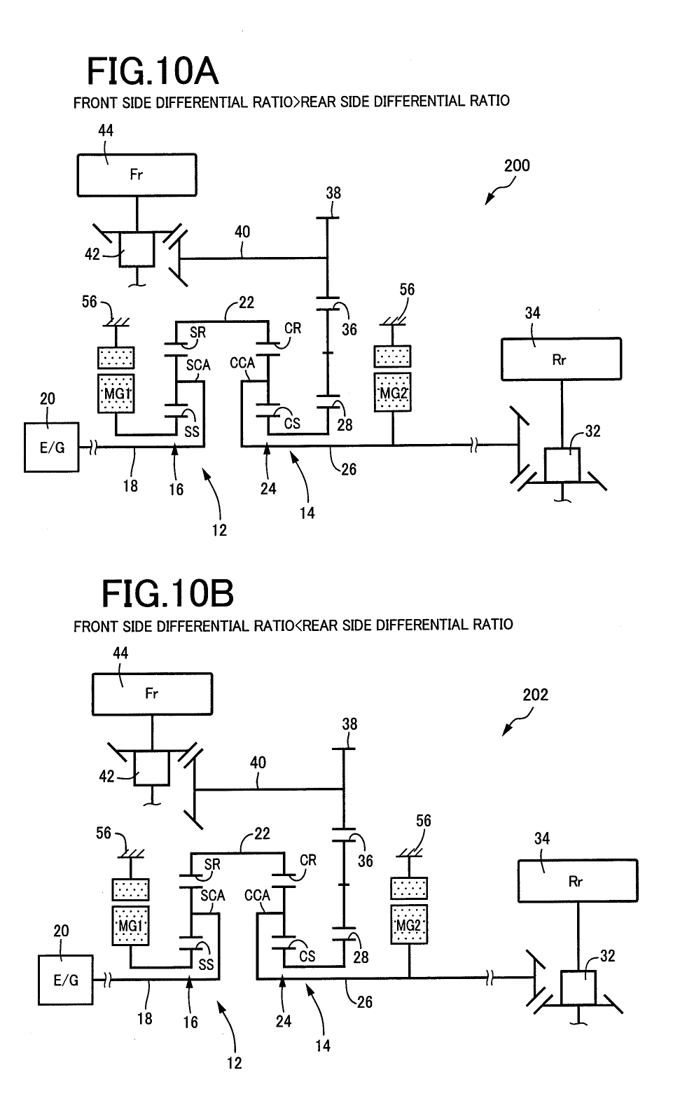

FIGS. 10A and 10B are schematics corresponding to FIG. 1 and depict the cases that the automatic transmission 30 is not included in both power transmission devices 200, 202. The power transmission device 200 of FIG. 10A has the final reduction ratio it on the rear wheel 34 side smaller than the previous embodiment and, as in the case that the gear stage of the automatic transmission 30 is set to the O/D gear stage “O/D” having the speed-increasing gear ratio in the previous embodiment, the gear ratio γr on the rear wheel side is smaller than the gear ratio γf on the front wheel side, and the rotation speed of the differential output member 22, i.e., the ring gear SR of the electric type differential portion 12 becomes lower as depicted in FIG. 8A. Since the rotation speed of the differential output member 22, i.e., the ring gear SR is set lower, the change in rotation of the first motor generator MG1 in the inverse rotation direction is suppressed and the energy circulation becomes difficult to occur or an energy loss due to the energy circulation is reduced, and the energy efficiency is improved.

The power transmission device 202 of FIG. 10B has the final reduction ratio if on the front wheel 44 side smaller than the previous embodiment and, as in the case that the gear stage of the automatic transmission 30 is set to the first speed gear stage “1st” or the second speed gear stage “2nd” having the speed-decreasing gear ratio in the previous embodiment, the gear ratio γr on the rear wheel side is greater than the gear ratio γf on the front wheel side and the rotation speed of the differential output member 22, i.e., the ring gear SR of the electric type differential portion 12 becomes higher as depicted in FIG. 8B. Since the rotation speed of the differential output member 22, i.e., the ring gear SR is set higher, the restriction on increase in the rotation speed of the differential input shaft 18 due to the rotation speed limitation of the first motor generator MG1 is alleviated, for example, and the rotation speed NE of the engine 20 coupled to the differential input shaft 18 can be increased to acquire excellent power performance (power).

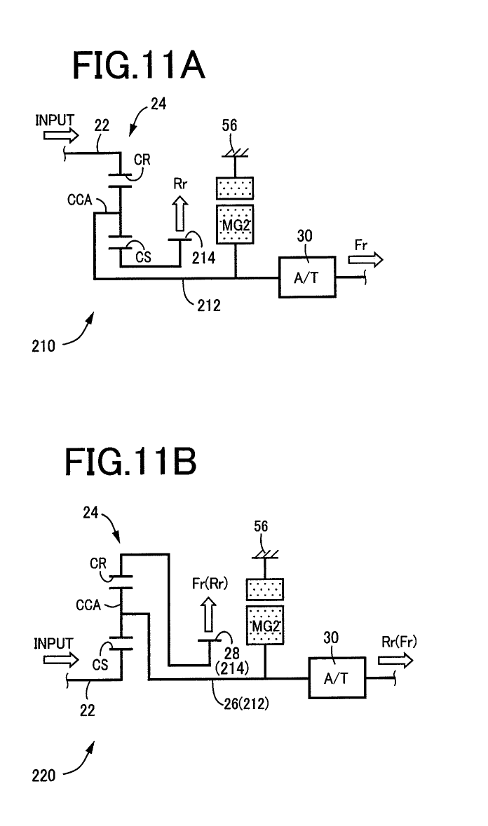

FIGS. 11A and 11B are schematics for explaining another example of the front and rear wheel power distribution device 14. A front and rear wheel power distribution device 210 of FIG. 11A corresponds to the case of a front and rear wheel drive vehicle based on a transverse type front wheel drive vehicle and, although the ring gear CR of the differential planetary gear device 24 is the input rotation element and is coupled to the differential output member 22 in the same way, the carrier CCA acting as the first output rotation element is coupled to a front-wheel output shaft 212; the front-wheel output shaft 212 is provided with the second motor generator MG2 and the automatic transmission 30; and the sun gear CS acting as the second output rotation element is coupled to a rear-wheel output gear 214. A bevel gear can be used as the rear-wheel output gear 214 and can directly be coupled to a propeller shaft, etc. In this case, substantially the same operational effect as the previous embodiment can be acquired except that the front and rear wheels are different.

In a front and rear wheel power distribution device 220 of FIG. 11B, the sun gear CS of the differential planetary gear device 24 is the input rotation element and is coupled to the differential output member 22; the carrier CCA is the first output rotation element and is coupled to the rear-wheel output shaft 26; and the ring gear CR is the second output rotation element and is coupled to the front-wheel output gear 28. In this case, the same operational effect as the previous embodiment can be acquired. The front and rear wheel power distribution device 220 is also applicable to a front and rear wheel drive vehicle based on a transverse type front wheel drive vehicle as is the case with FIG. 11A and, as depicted in parentheses, the carrier CCA acting as the first output rotation element may be coupled to the front-wheel output shaft 212 and the ring gear CR acting as the second output rotation element may be coupled to the rear-wheel output gear 214.

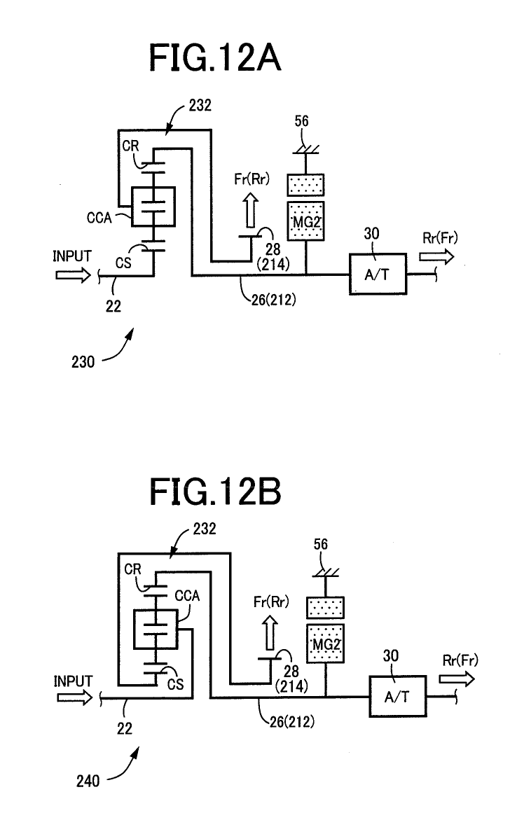

FIGS. 12A and 12B are schematics for explaining another example of the front and rear wheel power distribution device 14 and a double pinion type distribution planetary gear device 232 is used instead of the distribution planetary gear device 24. In a front and rear wheel power distribution device 230 of FIG. 12A, the sun gear CS of the distribution planetary gear device 232 is the input rotation element and is coupled to the differential output member 22; the ring gear CR is the first output rotation element and is coupled to the rear-wheel output shaft 26; and the carrier CCA is the second output rotation element and is coupled to the front-wheel output gear 28. In this case, the same operational effect as the previous embodiment can be acquired. The front and rear wheel power distribution device 230 is also applicable to a front and rear wheel drive vehicle based on a transverse type front wheel drive vehicle and, as depicted in parentheses, the ring gear CR acting as the first output rotation element may be coupled to the front-wheel output shaft 212 and the carrier CCA acting as the second output rotation element may be coupled to the rear-wheel output gear 214.

In a front and rear wheel power distribution device 240 of FIG. 12B, the carrier CCA of the distribution planetary gear device 232 is the input rotation element and is coupled to the differential output member 22; the ring gear CR is the first output rotation element and is coupled to the rear-wheel output shaft 26; and the sun gear CS is the second output rotation element and is coupled to the front-wheel output gear 28. In this case, the same operational effect as the previous embodiment can be acquired. The front and rear wheel power distribution device 240 is also applicable to a front and rear wheel drive vehicle based on a transverse type front wheel drive vehicle and, as depicted in parentheses, the ring gear CR acting as the first output rotation element may be coupled to the front-wheel output shaft 212 and the sun gear CS acting as the second output rotation element may be coupled to the rear-wheel output gear 214.

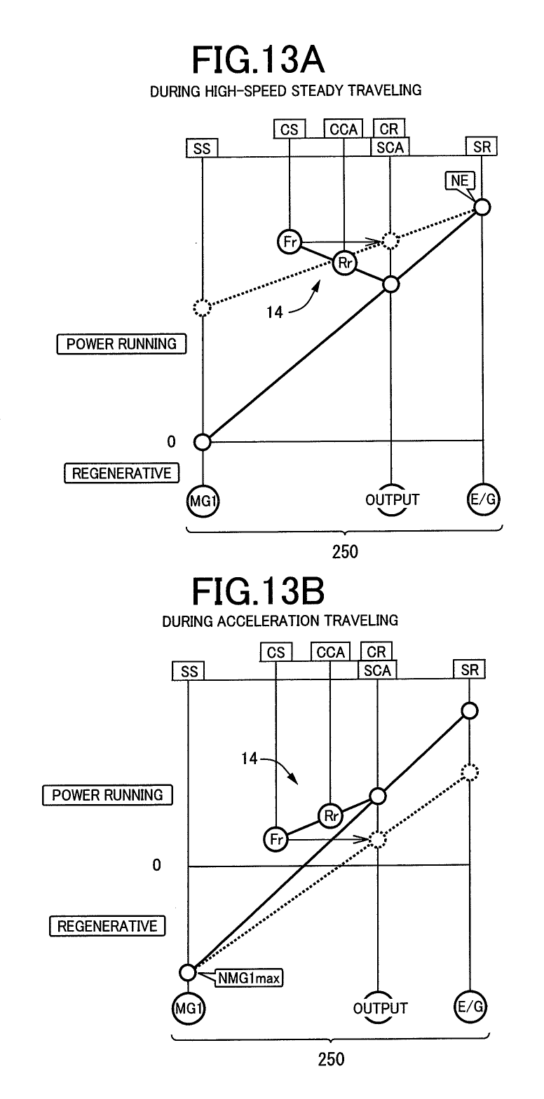

FIGS. 13A and 13B are collinear diagrams for explaining another examples of the electric type differential portion 12 and, in the case of an electric type differential portion 250, although the first motor generator MG1 is coupled to the sun gear SS of the differential planetary gear device 16 in the same way, the carrier SCA located in the middle on the collinear diagram is coupled to the differential output member 22 and the ring gear SR is coupled to the differential input shaft 18 and connected to the engine 20. In this case, while the first motor generator MG1 is rotated in the reverse direction and the regenerative control is performed during normal steady traveling and acceleration traveling, the power running control is performed such that the first motor generator MG1 is rotated in the positive rotation direction same as the differential output member 22 as needed during high-speed traveling. In this embodiment, as compared to the conventional hybrid represented by a broken line, while the rotation speed of the differential output member 22, i.e., the carrier SCA is reduced during high-speed traveling as shown in FIG. 13A, the rotation speed of the differential output member 22, i.e., the carrier SCA is increased during acceleration traveling as shown in FIG. 13B and, therefore, the same operational effect as the previous embodiment can be acquired. In other words, although the differential control by the high-speed traveling differential control means 92 is performed as needed during high-speed travelling, since the rotation speed of the differential output member 22, i.e., the carrier SCA is reduced, the rotation of the first motor generator MG1 in the positive rotation direction is suppressed and the energy circulation becomes difficult to occur or an energy loss due to the energy circulation is reduced, and the energy efficiency is improved. Although the differential control by the acceleration traveling differential control means 94 is performed as need during acceleration travelling, since the rotation speed of the differential output member 22, i.e., the carrier SCA is increased, the restriction on increase in the rotation speed of the differential input shaft 18 due to the rotation speed limitation of the first motor generator MG1 is alleviated and the rotation speed NE of the engine 20 coupled to the differential input shaft 18 can be increased to acquire excellent power performance (power).

Although the single pinion type differential planetary gear device 16 is used as a differential mechanism of the electric type differential portion 12 or 250 in the embodiments, a double pinion type differential planetary gear device can also be employed.

Although the embodiments of the present invention have been described in detail with reference to the drawings, these embodiments are merely exemplary embodiments and the present invention may be implemented in variously modified or altered forms based on the knowledge of those skilled in the art.

### INDUSTRIAL AVAILABILITY

Since the power transmission device of a front and rear wheel drive vehicle of the present invention is configured such that an input rotation element, a first output rotation element, and a second output rotation element are arranged in series from one end to the other end on a collinear diagram capable of representing the rotation speeds of the three rotation elements of the front and rear wheel power distribution device on a straight line, if a gear ratio from the first output rotation element to a first axle is different from a gear ratio from the second output rotation element to a second axle due to the presence/absence of the automatic transmission and a difference between the final reduction ratios of the front and rear wheel, the rotation speed is maximized or minimized in the input rotation element located at the end among the three rotation elements. Therefore, if the gear ratios are determined such that the rotation speed of the input rotation element is reduced during high-sped traveling, a change in the rotation is suppressed in the power running rotation direction of the first rotating machine coupled to the electric type differential portion correspondingly to the reduction of the rotation speed of the input rotating element, and the energy circulation becomes difficult to occur, and the energy efficiency is improved, while if the gear ratios are determined such that the rotation speed of the input rotation element is increased during acceleration traveling, a rotation speed of a differential input member is allowed to increase correspondingly to the increase in the rotation speed of the input rotation element and the rotation speed of a drive force source such as an engine coupled to the differential input member can be increased to acquired excellent power performance, which is preferably applied to various front and rear wheel drive vehicles requiring excellent energy efficiency and power performance.

1. A power transmission device for a front and rear wheel drive vehicle comprising:
an electric type differential portion having a differential state between a rotation speed of a differential input member and a rotation speed of a differential output member controlled by controlling an operational sate of a first rotating machine coupled to a rotating element of a differential mechanism in a power transmittable manner;
a second rotating machine disposed for at least one of front and rear wheels in a power transmittable manner; and
a front and rear wheel power distribution device having three rotating elements that are an input rotating element, a first output rotating element operatively coupled to a first wheel that is one of the front and rear wheels, and a second output rotating element operatively coupled to a second wheel that is the other of the front and rear wheels, the front and rear wheel power distribution device distributing power to the first output rotating element and the second output rotating element, the power being input from the differential output member to the input rotation element,
the front and rear wheel power distribution device being configured such that the input rotating element, the first output rotating element, and the second output rotating element are arranged in series from one end to the other end on a collinear diagram capable of representing rotation speeds of the three rotating elements on a straight line,
a gear ratio from the first output rotating element to the first wheel being different from a gear ratio from the second output rotating element to the second wheel.

2. The power transmission device for a front and rear wheel drive vehicle of claim 1, wherein
the gear ratio from the first output rotating element to the first wheel is smaller than the gear ratio from the second output rotating element to the second wheel.

3. The power transmission device for a front and rear wheel drive vehicle of claim 1, wherein
the gear ratio from the first output rotating element to the first wheel is greater than the gear ratio from the second output rotating element to the second wheel.

4.-6. (canceled)

7. The power transmission device for a front and rear wheel drive vehicle of claim 1, comprising a shifting portion on a power transmission path from the first output rotating element to the first wheel, the shifting portion having a gear ratio selectable from a speed-decreasing gear ratio larger than one to a speed-increasing gear ratio smaller than one, wherein
the gear ratio from the first output rotating element to the first wheel is made smaller than the gear ratio from the second output rotating element to the second wheel by selecting the speed-increasing gear ratio during high-speed traveling, and wherein the gear ratio from the first output rotating element to the first wheel is made greater than the gear ratio from the second output rotating element to the second wheel by selecting the speed-decreasing gear ratio during acceleration traveling.

8. The power transmission device for a front and rear wheel drive vehicle of claim 2, comprising a shifting portion on a power transmission path from the first output rotating element to the first wheel, the shifting portion having a gear ratio selectable from a speed-decreasing gear ratio larger than one to a speed-increasing gear ratio smaller than one, wherein
the gear ratio from the first output rotating element to the first wheel is made smaller than the gear ratio from the second output rotating element to the second wheel by selecting the speed-increasing gear ratio during high-speed traveling, and wherein the gear ratio from the first output rotating element to the first wheel is made greater than the gear ratio from the second output rotating element to the second wheel by selecting the speed-decreasing gear ratio during acceleration traveling.

9. The power transmission device for a front and rear wheel drive vehicle of claim 3, comprising a shifting portion on a power transmission path from the first output rotating element to the first wheel, the shifting portion having a gear ratio selectable from a speed-decreasing gear ratio larger than one to a speed-increasing gear ratio smaller than one, wherein
the gear ratio from the first output rotating element to the first wheel is made smaller than the gear ratio from the second output rotating element to the second wheel by selecting the speed-increasing gear ratio during high-speed traveling, and wherein the gear ratio from the first output rotating element to the first wheel is made greater than the gear ratio from the second output rotating element to the second wheel by selecting the speed-decreasing gear ratio during acceleration traveling.

10. The power transmission device for a front and rear wheel drive vehicle of claim 2, comprising a high-speed traveling differential control means that performs power running control to rotationally drive the first rotating machine depending on the rotation speed of the differential output member such that the rotation speed of the differential input member is maintained at a predetermined value during acceleration traveling while performing regenerative control of the second rotating machine to recover electric energy.

11. The power transmission device for a front and rear wheel drive vehicle of claim 7, comprising a high-speed traveling differential control means that performs power running control to rotationally drive the first rotating machine depending on the rotation speed of the differential output member such that the rotation speed of the differential input member is maintained at a predetermined value during acceleration traveling while performing regenerative control of the second rotating machine to recover electric energy.

12. The power transmission device for a front and rear wheel drive vehicle of claim 8, comprising a high-speed traveling differential control means that performs power running control to rotationally drive the first rotating machine depending on the rotation speed of the differential output member such that the rotation speed of the differential input member is maintained at a predetermined value during acceleration traveling while performing regenerative control of the second rotating machine to recover electric energy.

13. The power transmission device for a front and rear wheel drive vehicle of claim 9, comprising a high-speed traveling differential control means that performs power running control to rotationally drive the first rotating machine depending on the rotation speed of the differential output member such that the rotation speed of the differential input member is maintained at a predetermined value during acceleration traveling while performing regenerative control of the second rotating machine to recover electric energy.

14. The power transmission device for a front and rear wheel drive vehicle of claim 3, comprising an acceleration traveling differential control means that performs regenerative control of the first rotating machine during acceleration traveling to recover electric energy while limiting the rotation speed of the first rotating machine during the regenerative control in accordance with a predetermined regenerative condition.

15. The power transmission device for a front and rear wheel drive vehicle of claim 7, comprising an acceleration traveling differential control means that performs regenerative control of the first rotating machine during acceleration traveling to recover electric energy while limiting the rotation speed of the first rotating machine during the regenerative control in accordance with a predetermined regenerative condition.

16. The power transmission device for a front and rear wheel drive vehicle of claim 8, comprising an acceleration traveling differential control means that performs regenerative control of the first rotating machine during acceleration traveling to recover electric energy while limiting the rotation speed of the first rotating machine during the regenerative control in accordance with a predetermined regenerative condition.

17. The power transmission device for a front and rear wheel drive vehicle of claim 9, comprising an acceleration traveling differential control means that performs regenerative control of the first rotating machine during acceleration traveling to recover electric energy while limiting the rotation speed of the first rotating machine during the regenerative control in accordance with a predetermined regenerative condition.
